(19) United States
(12) Patent Application Publication
(10) Pub. No.: US 2022/0074762 A1
(43) Pub. Date: Mar. 10, 2022

(54) Exploration Of A Robot Deployment Area By An Autonomous Mobile Robot

(71) Applicant: RobArt GmbH, Linz (AT)

(72) Inventors: Harold Artes, Linz (AT); Daniel Bartel, Linz (AT); Dominik Seethaler, Linz (AT); Reinhard Vogel, Linz (AT)

(73) Assignee: RobArt GmbH, Linz (AT)

(21) Appl. No.: 17/272,489

(22) PCT Filed: Aug. 30, 2019
(86) PCT No.: PCT/AT2019/060284

§ 371 Date: Nov. 23, 2021

(30) Foreign Application Priority Data
Aug. 31, 2018 (DE) 10 2018 121 365.4

(51) Int. Cl. G01C 21/00; G05D 1/02; G06K 9/00

(52) U.S. Cl. CPC G01C 21/3859; G05D 1/0274; G01C 21/3837; G05D 2201/0215; G06K 9/00664; G05D 2201/0203; G05D 1/0214

(57) ABSTRACT

An exemplary embodiment relates to a method for an autonomous mobile robot for the new exploration of an area already listed in a map of the robot. According to one example, the method comprises storing a map of a deployment area of an autonomous mobile robot, wherein the map contains orientation information, which represents the structure of the surroundings in the deployment area, and also meta information. The method further comprises receiving a command via a communication unit of the robot, which causes the robot to start a new exploration of at least a part of the deployment area. The robot then explores again the at least one part of the deployment area, wherein the robot detects information regarding the structure of its surroundings in the deployment area by means of a sensor. The method further comprises updating the map of the deployment area and storing the updated map for use in the robot navigation during a plurality of future robot interventions. The aforementioned update comprises determining changes in the deployment area based on the information recorded during the exploration about the structure of the surroundings and the orientation information already stored in the map, and updating the orientation information and the meta information based on the determined changes.

### TECHNICAL FIELD

The present invention is related to the field of autonomous mobile robots, in particular robots that employ a map-based navigation.

### BACKGROUND

In recent years, autonomous mobile robots, in particular, service robots, are being increasingly used in households, for example, for cleaning or for monitoring a deployment area such as an apartment. In this context robot systems are being increasingly used that compile a map of the area for navigation using a SLAM (simultaneous localization and mapping) algorithm. For this purpose, a map is compiled, and the robot's position on the map is determined with the aid of sensors (laser range scanners, cameras, contact sensors, odometers, acceleration sensors, etc.).

The thereby compiled map can be permanently saved and used for subsequent deployments of the robot. In this manner the robot can be specifically sent to a deployment area in order to complete a task such as, for example, the cleaning of a living room. In addition to this, the work sequence of the robot can be more efficiently scheduled as the robot can make use of the previous knowledge regarding its area of deployment that is stored in the map to plan in advance.

There are essentially two different strategies that can be employed when working with a permanently stored map. One of these entails using the map, once compiled, without changes until the user decides to discard it. In this case a new map has to be compiled and all of the entries and adaptations carried out by the user have to be once again included into the map. In particular in living environments in which changes often take place this will result in increased and unwanted effort on the part of the user. Alternatively, the strategy may be to enter every change into the map in order to take these into account during the next deployment. In this way, for example, temporarily closed doors can be recorded in the map as obstacles that close off all possible paths into the room beyond the door. This prevents the robot from entering the room and seriously limits the functionality of the robot.

A further problem involves the stability of the map and the degree of efficiency with which it is compiled. A map should include as many details as possible. As this has to be achieved using sensors that have a limited range of reception, in currently used robot systems the entire area of deployment must first be examined in an exploration run, which can take up a considerable amount of time. The problem may be further aggravated by obstacles (e.g. loose cables or a shag carpet) that hinder the robot's movement, resulting in unanticipated interruptions of the exploration run. These problems can so seriously affect the accuracy of the map so as to render it unusable. If, for this reason, the exploration run has to be restarted, the robot will no longer have a record of the areas it already examined, which will cost the user a great deal of time and patience.

It is therefore the underlying objection of the present invention to render the compilation of the map more stable and efficient. Furthermore, the compiled map should remain stable while still being capable of being adapted to changes in the environment.

### SUMMARY

The aforementioned objective is achieved by the method in accordance with claims 1, 12, 19, 24 and 28, as well as by the robot in accordance with claim 11 or 37. Various embodiments and further developments form the subject matter of the dependent claims.

One embodiment relates to a method for an autonomous mobile robot to again explore an area already designated on the map of the robot. In accordance with one example, the method comprises saving a map of a deployment area of an autonomous mobile robot, wherein the map contains orientation data that represents the structure of the environment in the area of deployment, as well as metadata. The method further comprises receiving a command via a communication unit of the robot that induces the robot to start a renewed exploration of at least a part of the deployment area. Upon command the robot then once again examines at least part of the deployment area, whereby the robot gathers information concerning the structure of its surrounding area of deployment by means of a sensor. The method further comprises updating the map of the deployment area and saving the updated map for further use during navigation of the robot through numerous future robot deployments. Updating the map entails detecting changes in the area of deployment based on data collected during the examination of the structures in the environment, as well as on orientation data already stored in the map. This further entails updating the orientation data and the metadata based on the detected changes.

Further, an autonomous mobile robot will be described. In accordance with one embodiment, the robot comprises the following: a drive unit for moving the robot through an area of robot deployment, a sensor unit for gathering information about the structure of the deployment area environment, as well as a control unit with a navigation module that is configured to compile a map of the deployment area by carrying out an exploration run through the area and to permanently save the map for use in future deployments of the robot. The robot further comprises a communication unit for receiving a user command to carry out a service task, as well as a user command to update the saved map. The navigation module is further configured to make use of the saved map and of the data collected by the sensor unit to navigate the robot through the robot deployment area while it is carrying out its service task, wherein the data contained in the stored map and which is needed for navigation while the service task is being carried out is not permanently changed. The navigation module is further configured, upon receiving a user command to update the stored map, to once again at least partially explore the robot deployment area and, while carrying out the exploration, to update the data saved in the map and which is needed for navigation.

A further method relates to the robot-supported search for objects and/or events that are to be sought after in a deployment area carried out by an autonomous mobile robot. For this purpose the robot is configured to permanently store at least one map of a robot deployment area for use during future deployments of the robot and to gather data relating to the environment of the robot in its deployment area by means of a sensor unit and, based on the data relating to objects and/or events collected within the detection range of the sensor unit, to detect and locate these with a given degree of accuracy. In accordance with one example, the method comprises navigating the robot through the deployment area, making use of the saved map, in order to find sought-after objects and/or events in the area, determining the position of a sought-after object and/or event in relation to the map after it has been detected and localized by means of a sensor of the sensor unit, and entering the region of the deployment area covered by the detection range of the respective sensor into the map. The steps of determining the position and entering the region covered by the detection range of the sensor are repeatedly carried out until a termination criterion is fulfilled.

A further method relates to the robot-supported exploration of an area. In accordance with one example the method comprises: compiling a map of a deployment area of an autonomous mobile robot during an exploration run through the deployment area, wherein the robot navigates through the area of deployment with the aid of sensors that gather information about its environment and detect its position in the area; detecting a problem that hinders the navigation of the robot and the subsequent compilation of the map; determining a point in time and/or a location in the map compiled up until the detection of the problem that can be attributed to the detected problem; detecting when an unobstructed further navigation once again becomes possible; and continuing the compilation of the map, taking into consideration the point in time and/or location attributed to the problem, wherein the robot determines the position on the map at which it was located when the problem was detected and the information associated with this position while compiling the rest of the map.

A further example described here refers to a method for an autonomous mobile robot in which the robot navigates through a certain area using a map, in the process determines a measured value which represents the surface of the area that is actually accessible, and from this determines a value for the accessibility of an area based on the first measured value and on a stored reference value. A user is notified of the value determined for the accessibility of the given area.

Finally, a method for exploring a robot deployment area using an autonomous mobile robot for the purpose of compiling a map of the area of robot deployment will be described. In accordance with one example, the method comprises the following: exploring the area of deployment in a first mode of operation in accordance with a first exploration strategy, in accordance with which the robot detects first structures in a first detection area by means of a sensor unit, as well as second structures in a second detection area; exploring the area of robot deployment in a second mode of operation in accordance with a second exploration strategy if the robot detects a second structure while in the first mode of operation; and compiling the map based on the structures detected while in the first mode of operation and while in the second mode of operation and saving the map for use in navigation in subsequent deployments of the robot.

Further, examples of autonomous mobile robots that are implemented to carry out the methods described here will be described.

### SHORT DESCRIPTION OF THE FIGURES

The invention will now be described in detail based on the examples illustrated in the figures. The illustrations are not necessarily true to scale and the invention is not limited to only the aspects illustrated here. Instead importance is given to illustrating the underlying principles of the invention.

FIG. 1 exemplarily illustrates an autonomous mobile robot in its area of robot deployment.

FIG. 2 is an exemplary block diagram in which various units of an autonomous mobile robot, as well as peripheral devices such as, for example, a base station of the robot, are illustrated.

FIG. 3 illustrates an example of an area of deployment for an autonomous mobile robot.

FIG. 4 visualizes the orientation data referring to the deployment area shown in FIG. 3 gathered by the robot.

FIG. 5 illustrates the map of the robot deployment area in accordance with FIG. 3, as well as the metadata contained in the map.

FIG. 6 illustrates the detection of obstacles using a sensor that has a defined detection range (a defined range of vision).

FIG. 7 illustrates the movement of the robot during an exploration run through the area of deployment, as well as the regions of the deployment area that have already been explored.

FIG. 8 illustrates a first example of the procedure followed while exploring an area of robot deployment for the compilation of a map.

FIG. 9 illustrates a second example of the procedure followed while exploring an area of robot deployment for the compilation of a map.

FIG. 10 illustrates a third example of the procedure followed while exploring an area of robot deployment, in this case taking into consideration the situation in which the robot confronts a problem.

FIG. 11 illustrates a problem with which the robot may be confronted during an exploration run.

FIG. 12 illustrates the area of deployment shown in FIG. 3 with numerous changes that are to be detected by the robot.

FIG. 13 illustrates the detection range of a sensor that is taken into consideration when an area is examined.

### DETAILED DESCRIPTION

An autonomous mobile robot independently carries out one or more tasks in a robot deployment area. Examples for such tasks may include the cleaning of a floor surface in the area of deployment, the monitoring and examination of the robot deployment area, the transport of objects within the area of deployment (e.g. in an apartment) or other activities, even including entertaining the user. These tasks pertain to the actual purpose of a service robot and are therefore referred to as service tasks. The service tasks described here relate primarily to a cleaning robot. They are not, however, limited to cleaning robots but are instead suitable for all applications in which an autonomous mobile robot is to carry out a task in a defined area of deployment, through which it can independently move and navigate with the aid of a map.

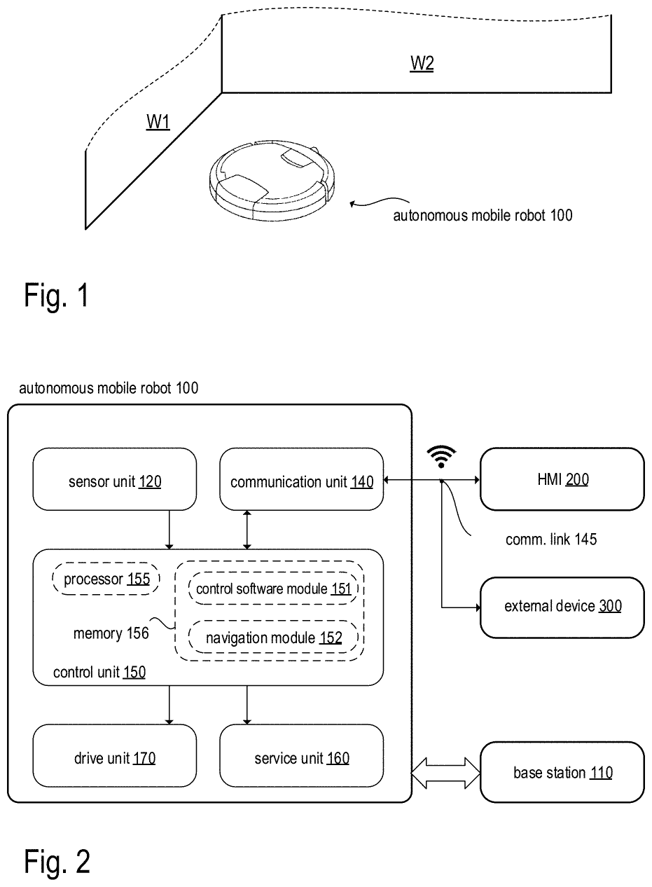

FIG. 1 exemplarily illustrates an autonomous mobile robot 100, in particular, a cleaning robot. Other examples of autonomous mobile robots include, among others; transport robots, surveillance robots, telepresence robots, etc. Modern autonomous mobile robots use a map-based navigation, i.e. they have an electronic map of their area of deployment at their disposal. In some situations, however, the robot has no map, or no up-to-date map, of the deployment area at its disposal and it is required to explore its (still unknown) environment and to compile a map of it. This process is also referred to as an exploration run, a learning run or simply “exploration”. During exploration the robot detects obstacles as it moves through the robot deployment area. In the example illustrated in FIG. 1, the robot 100 has already recognized portions of the walls W1 and W2 in a room. Methods for exploring and mapping the environment of an autonomous mobile robot are widely known. For example, the robot can travel over the entire accessible surface while compiling the map using a SLAM method (simultaneous localization and mapping). Carrying out an exploration is not a service task, that is, it is not one of the activities for which the robot is actually intended (such as cleaning a floor surface). This does not prevent the robot, however, from carrying out a service task simultaneously while conducting an exploration run. During deployment the robot can complete one or more service tasks while carrying out supplemental tasks such as, for example, the exploration of a deployment area for the compilation or update of a map.

FIG. 2 exemplarily shows, making use of a block diagram, various units of an autonomous mobile robot 100. One such unit may comprise an independent component or may be a portion (module) of software for controlling the robot. One unit may also comprise numerous subunits. A unit may be completely implemented as hardware or as a combination of hardware and software (e.g. firmware). The software responsible for the behavior of the robot 100 can be run on the control unit 150 of the robot 100. In the example illustrated here, the control unit 150 contains a processor 155 which is configured to execute software instructions saved in a memory 156. Some of the functions of the control unit 150 may be at least partially carried out with the aid of an external computer. This means that the computing power needed by the control unit 150 can be provided, at least partially, by an external computer that the robot can access, for example, via a local network (e.g. WLAN, wireless local area network), or via the internet. For example, the external computer may provide a cloud computing service.

The autonomous mobile robot comprises a drive unit 170, which may comprise, for example, an engine controller for controlling the electromotors, as well as a transmission and wheels. With the aid of the drive unit 170, the robot 100 can—at least theoretically—access every point in its area of deployment. The drive unit 170 (e.g. the aforementioned engine controller) is configured to convert commands or signals into a movement of the robot 100.

The autonomous mobile robot 100 comprises a communication unit 140 for establishing a communication link 145 to an HMI (human machine interface) 200 and/or to other external devices 300. The communication link 145 is, for example, a wireless connection (e.g. Bluetooth), a local wireless network (e.g. WLAN or ZigBee) or an internet connection (e.g. to a cloud service). The human machine interface 200 can provide the user with information regarding the autonomous mobile robot 100, for example, in visual or acoustic form (e.g. loading status of batteries, present work task, map information such as a cleaning map, etc.) and can receive user commands. A user command may be, for example, a work task for the autonomous mobile robot 100 to carry out.

Examples of HMIs 200 include tablet PCs, smartphones, smartwatches and similar wearables, personal computers, smart-TVs or head-mounted displays, among others. An HMI 200 may be directly integrated in the robot, in which case the robot can be operated, for example, by means of buttons, gestures and/or vocal input and output.

Examples of external devices 300 include computers and servers onto which computations and/or data can be offloaded, external sensors that provide additional data or other household devices (e.g. other autonomous mobile robots) with which the autonomous mobile robot 100 can cooperate and/or exchange information.

The autonomous mobile robot 100 may be equipped with a service unit 160 for performing service tasks (see FIG. 2). The service unit 160 may be, for example, a cleaning unit for cleaning a floor surface (e.g. brushes, a vacuuming device), or it may be a gripper arm for gripping and transporting objects. In the case of a telepresence robot, the service unit 160 may comprise a multimedia unit consisting of, for example, a microphone, a camera and a display screen in order to allow numerous users to communicate over long distances. A robot designed for surveillance or examination (e.g. a night watchman robot) detects unusual events (e.g. fire, light, unauthorized persons) with the aid of sensors while completing its monitoring runs and informs, for example, a control center of the event. For this purpose the service unit 160 includes all functions needed to detect an unusual event.

The autonomous mobile robot 100 comprises a sensor unit 120 with various sensors, for example, one or more sensors for gathering data about the structure of the robot's environment in its area of deployment such as, for example, the position and dimensions of obstacles or of landmarks in the area of deployment. Sensors for collecting data on the environment include, for example, sensors for measuring the distance to objects (e.g. to walls or other obstacles, etc.), in the robot's environment such as, for example, optical and/or acoustic sensors that can measure distances by means of triangulation or runtime measurement of an emitted signal (triangulation sensors, 3D cameras, laser scanners, ultrasonic scanners, etc.). In addition or as an alternative, a camera may be used to gather information about the environment. In particular, by viewing an object from two or more positions, the position and dimensions of an object can also be determined.

In addition to this, the sensor unit 120 of the robot may comprise sensors that are capable of detecting an (at least unintended) contact (e.g. a collision) with an obstacle. This detection can be realized by means of acceleration sensors (which, for example, detect the change in the robot's speed that takes place upon collision), contact sensors, capacitive sensors or other tactile (sensitive to touch) sensors. Further, the robot may have floor sensors to measure the distance to the floor or to detect a change in the distance to the floor (e.g. when a dangerous precipice such as, for example, a stair ledge appears). Other sensors with which robots are often equipped include sensors for determining the speed and/or the distance travelled by the robot such as, e.g. odometers and other inertia sensors (acceleration sensors, rotation rate sensors) for determining changes in the position and movement of the robot, as well as wheel contact sensors for detecting a contact between a wheel and the floor. The sensors are configured, for example, to detect structural characteristics of a floor surface such as, for example, the type of floor covering, the borders of the floor covering and/or sills (e.g. of doors). This is generally carried out using images recorded by a camera, measurements of the distance between robot and floor surface and/or gauging the change in the robot's stance when it moves over a sill (e.g. be means of inertia sensors).

The autonomous mobile robot 100 may be assigned to a base station 110 at which, for example, it can replenish its power supply (load batteries). The robot 100 can return to this base station 110 after completing its tasks. When the robot 100 has no further tasks to complete, it can wait in the base station 110 for its next deployment.

The control unit 150 may be configured to provide all functions needed by the robot to independently move throughout its area of deployment and to carry out its tasks. For this purpose the control unit 150 may comprise, for example a memory module 156 and a processor 155 that is configured to execute the software instructions stored in the memory. The control unit 150 can generate control commands (e.g. control signals) for the service unit 160 and the drive unit 170 based on data received by the sensor unit 120 and the communication unit 140. The drive unit 170, as previously mentioned, can convert these control commands or control signals into a movement of the robot. The software stored in the memory 156 may also be modally implemented. A navigation module 152 provides the functions, for example, that are needed to automatically compile a map of the deployment area, to determine the position of the robot 100 in this map, and to plan the movements (i.e. plan the path) of the robot 100. The control software module 151 provides, for example, general (global) control functionality and may serve as an interface between the individual modules.

Navigation module and maps—In order that the robot be capable of carrying out a service task autonomously, the control unit 150 may include functions for navigating the robot through its area of deployment, which can be provided, for example, by the aforementioned navigation module 152. Such functions are generally well known and may include, among others, one or more of the following:
the compilation of (electronic) maps by collecting data on the environment with the aid of the sensor unit 120, for example, but not limited to, by means of a SLAM method;
the determination of the position of the robot in a map with no or very little prior information based on the information on the environment gathered by the sensor unit 120 (global self-localization);
map-based path planning (trajectory planning) from a current position of the robot (the starting point) to a given destination;
the capability of interpreting the map and the environment, i.e. to identifying rooms or other subareas (e.g. by recognizing known doors, borders between differing floor coverings, etc.);
the management of one or more maps of one or more corresponding areas of robot deployment.

FIG. exemplarily shows a deployment area DA for an autonomous mobile robot 100, as well as its present position within the deployment area. The position of the robot can be described as a point on the plane of movement (e.g. the center point of the robot) and as its orientation (e.g. faced forward). The position and orientation of the robot are sometimes together referred to as pose. The deployment area may be, for example, an apartment with numerous rooms (e.g. kitchen, living room, hallway, bedroom) that have different furniture and floor coverings. In order to be capable of moving through this deployment area, the robot 100 needs a map 500 of the deployment area DA. This map can be compiled by the robot on its own and be permanently saved. In this context, “permanently saved” means that the map is remains available for use in navigation (planning and executing the robot's movements) in any given number of future robot deployments. This is not meant to imply that the map cannot be modified or deleted, but only that it is stored in the memory for reuse in an undetermined number of future robot deployments. As opposed to a permanently saved map, a temporarily saved map is only compiled for a current deployment of the robot and it is subsequently discarded (i.e. not used again).

In general, an (electronic) map 500 for use by the robot 100 is a compilation of map data in which information is stored that relates to a deployment area DA of the robot and to the, for the robot relevant, environment within this deployment area. Thus a map represents numerous sets of data containing map data and these map data may contain any desired information relating to the environment. Aspects considered in such a data set such as, for example, an identified soiled area, a completed cleaning or recognized rooms may also be depicted in a map (in particular, in a soiled areas map, a cleaning map, a room map).

One important technical prerequisite for the robot 100 to be capable of handling a multitude of area-related data is the recognition of its own position. This means that the robot has to be capable of orienting and locating itself as accurately and reliably as possible. For this purpose the map 500 contains orientation data 505 (also referred to as navigation features) that represents, for example, the position in the deployment area of landmarks and/or obstacles. In the orientation data the location is generally defined in coordinates. The orientation data comprises, for example, map data processed using a SLAM method.

In addition to the orientation data, the robot gathers further information about its area of deployment that may be relevant for navigation and/or for its interaction with a user, but which may not be needed to determine the position of the robot. This information may be based on sensor measurements (e.g. a soiled area), a service task (e.g. a cleaned surface), an interpretation of the orientation data 505 regarding the environment saved in the map that the robot itself carries out (e.g. recognizing a room) and/or a user input (e.g. room names, an exclusion zones, time schedules, etc.). This data in its entirety will be referred to hereinafter as “metadata”.

FIG. 4 exemplarily illustrates orientation data 505 of a map 500 of a deployment area DA that a robot can use to orient itself and with the aid of which the robot can locate itself. As mentioned, such orientation data 505 can be collected by the robot itself, e.g. by means of sensors and can be compiled using a SLAM algorithm and entered into a map. For example, the robot measures the distance to obstacles (e.g. a wall, a piece of furniture, a door, etc.) by means of a distance sensor and calculates line segments from the measured values (usually a point cloud) that define the borders of its deployment area. The robot deployment area may be defined, for example, by a closed chain of line segments (polygonal line). Beyond this, there may be further obstacles located within the area of deployment that are represented in the orientation data. An alternative to the mentioned chain of line segments would be a raster map, in which a raster of cells (each measuring, e.g. 10×10 cm²) is laid over the robot deployment area and each cell is marked as either containing an obstacle or free of obstacles. A still further possibility would be to compile a map on the basis of image data recorded by a camera, wherein the image data is also linked to a location at which the image was taken. The image data can also be recognized by the robot and used to locate and orient itself in its environment.

Based on the specific structure of the orientation data, the robot can determine its position in the deployment area. There are known methods for global self-localization with which the robot can determine its position in the deployment area, with no or only little available data on it, based on the orientation data at its disposal. This may be necessary, for example, after the robot is turned off and on again or moved. The methods used for global self-localization are principally different from the position tracking methods (e.g. based on odometry) used when carrying out a SLAM procedure as global self-localization functions without any previously obtained data concerning the position of the robot.

When the robot's 100 area of deployment 200 is a living environment, it is constantly subject to changes carried out by the inhabitants. Doors may be opened and closed, new obstacles (e.g. a bag, a standing lamp, etc.) may be temporarily or permanently placed in the robot deployment area. These changes bring about corresponding changes in certain aspects of the orientation data. Other aspects, however, in particular the positions of walls, larger pieces of furniture (wardrobe, couch) generally remain unchanged, which facilitates a robust navigation. Conventional methods for navigating the robot can also be implemented to be robust in changing environments.

In the long term, however, the navigation of the robot can be disrupted, for example, when obstacles (e.g. a closed door) are indicated in the map that are not present, or when presently existing obstacles are not indicated in the map. In order to avoid disruptive influences from earlier deployments, the map 500 can be compiled in an exploration or learning run after the user has tidied up the apartment as well as possible. This map 500 is then permanently stored. A work copy of the map can be used when carrying out a service task (e.g. cleaning, transporting, examining, entertaining, etc.). All changes that are of relevance for carrying out the service task are contained in the work copy, whereas the permanently saved map 500 remains unchanged. The work copy, and the changes to the map 500 contained in it, can thus be discarded after the task is completed, leaving the map 500 unchanged. This prevents undesired changes to the permanently saved map 500 by ensuring, for example, that obstacles which are only temporarily placed in the deployment area or mapping errors that occur during a deployment (e.g. erroneous measurements or as a result of navigation problems) are not entered into the permanently saved map 500.

Alternatively or additionally, the changes may be analyzed and assessed, e.g. by comparing the work copy to the permanently saved map. The results of this analysis can be included into the permanently saved map 500, thereby enabling the robot to continuously learn and adapt its behavior to its environment. In order to avoid any negative consequences for the orientation capabilities of the robot that this might bring, this information can be stored as metadata 510, leaving the orientation data 505 of the permanently saved map 500 unchanged. For example, it may only be possible to update the orientation data 505 after receipt of a user confirmation. It may also be required that a new exploration run be completed before the orientation data 505 can be updated, for example. Details concerning the assessment of changes to the environment and concerning a new exploration run will be discussed further below after first detailing, in the following, the aforementioned metadata.

Metadata is the location-specific data in the map that is not needed for the determination of the robot's position. This data can be used, for example, to help the robot “learn” more about its environment and better adapt to it, as well as to render the user—robot interaction more efficient. The metadata may also be used, for example, to improve the path and work planning. For example, some of (but not only) the following information may be included in the metadata:
information stemming from user input;
information learned over the course of numerous deployments of the robot, in particular (statistical) information, e.g. concerning the duration of the processing of a service task, the frequency with which a service task is carried out, problems arising during navigation, soiling specifics;
information regarding the division of the deployment area into subareas (e.g. individual rooms) and the designations of these rooms, subareas and/or further objects;
information on specific attributes of rooms and/or subareas, in particular, their dimensions, the floor properties (e.g. floor coverings in subareas) and exclusion zones;
schedules and specifications of service tasks, including the time needed to complete a particular service task in a subarea;
topological map information and contextual information (e.g. links between surfaces and rooms); and
information concerning the accessibility of paths.

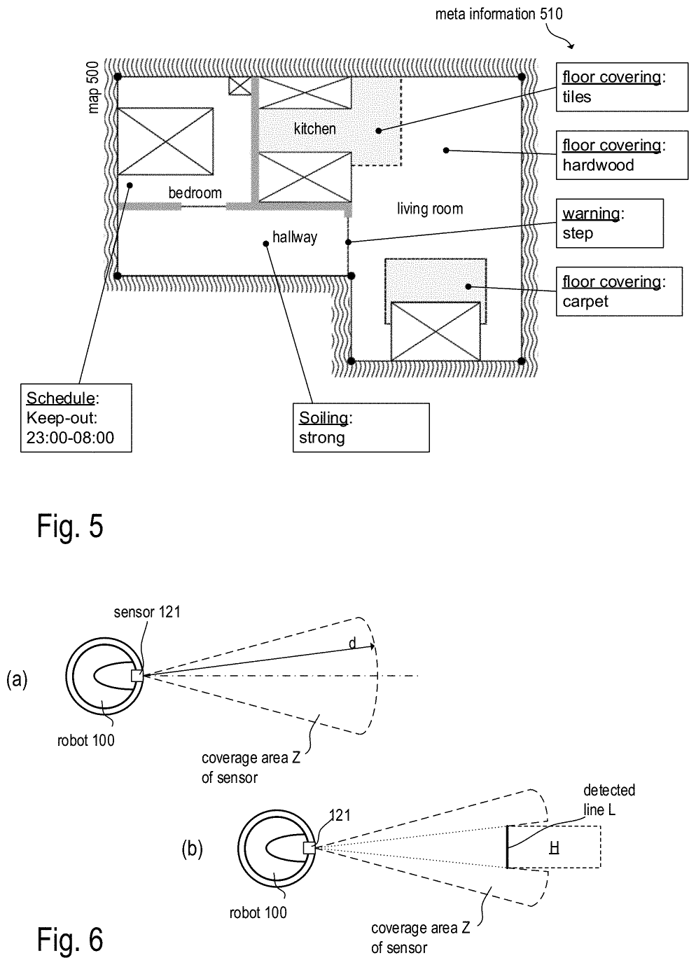

FIG. 5 exemplarily illustrates the metadata 510 in the permanently saved map 500 of the deployment area DA. Examples are shown of: the designation of rooms (e.g. “hallway”, “bedroom”, “living room”, “kitchen”, etc. for a natural user—robot interaction), schedules for planning tasks (e.g. “Keep out from 11 pm to 6 am.”), specifics regarding the soiled area (e.g. “recurrent heavy soiling in hallway”—robot cleans more frequently), properties of the floor covering (e.g. “hardwood”, “tiles”, “carpet”, etc. and any specific service tasks connected therewith), warning notices (e.g. “step”—robot proceeds slowly), etc.

One kind of metadata that can be stored in a map is the division of the robot deployment area into numerous rooms and/or subareas. This division may be carried out automatedly by the robot 100, for which it can analyze and interpret the orientation and other data gathered during the exploration run, for example. Additionally or alternatively to this, the user can perform the division manually and/or they can manually modify an automatedly performed division. The designation of the rooms (e.g. “hallway”, “living room”, “bedroom”, etc. may, as mentioned, also form part of the metadata.

The user can determine, for example, whether a certain room and/or subarea may be accessed or not. For example, the user can designate a subarea as a “virtual exclusion zone” or “keep-out area” to prohibit the robot from entering it on its own. This function is particularly useful when the subarea cannot be safely travelled through by the robot or when the robot would disturb a user in the subarea.

As an alternative or in addition to this, the user can create, modify and delete user-defined subareas. User-defined subareas may define, for example, areas that the robot is not permitted to enter on its own (exclusion zones) or, on the other hand, areas that the user specifically wants to have cleaned regularly or more or less frequently.

The metadata may also refer to objects that the robot can readily identify, including their significance and designation. For example, one or more properties (features) may be attributed to an object designated in the map. For example, specific attributes referring to accessibility (“free”, “blocked by obstacle”, “no entry”), to the processing status (“not cleaned”, “cleaned”) and/or the floor covering (“carpet”, “hardwood”), etc., can be assigned to the surface elements recorded in the map.

The information contained in the metadata may also refer to the surfaces that are accessible to the robot and/or the surfaces that can be cleaned. For this purpose, the size and/or the exact shape and dimensions of the accessible/cleanable surface of each individual subarea and/or of the robot deployment area in its entirety can be recorded and saved. This surface can then serve as a reference by which, for example, the results of a service task (e.g. the cleaned surface vs. the theoretically cleanable surface) can be assessed.

As mentioned, metadata can be based on user input and/or on an interpretation of the orientation data saved in the map carried out by the robot 100. Information regarding danger zones can also be in the metadata. Such zones may have, for example, loose cable lying about that could gravely hinder the navigation and movement capabilities of the robot. Such areas could be navigated by the robot with particular care or could be avoided altogether. For example, the robot can learn to recognize such a zone independently by linking navigation or movement problems that occurred in a preceding deployment (or during an exploration run) to their corresponding positions in the map. Alternatively, danger zones may also be defined by the user.

Exploration Run for the Compilation of a Map—A permanently saved map can be compiled by the robot itself in a preceding deployment, for example, or in an exploration run, or the robot can be provided with the map by another robot and/or a user, and the map is permanently saved, for example, in a memory 156 (cf. FIG. 2). Alternatively, the map of the robot deployment area that is to be permanently saved can be stored outside of the robot, for example, on a computer in the household of the robot's user (e.g. a tablet PC, a home server) or on a computer that can be accessed via internet (e.g. a cloud server). The map data may also be saved and managed by the navigation module 152, for example.

An exploration run can start from any point in the deployment area such as, for example, from the base station. At the beginning of the exploration run, the robot knows little or nothing about its environment. During its exploration run through the area of deployment, the robot 100 uses its sensors to collect data regarding the structure of the environment, in particular, data regarding the position of obstacles and other orientation data, and with this data the robot compiles the map. For example, walls and other obstacles (e.g. furniture and other objects) are detected and their location and position is recorded in the map. The sensor systems used for such detection are commonly known and may be integrated in a sensor unit 120 of the robot 100 (cf. FIG. 2). The computation needed for the detection can be performed by a processor integrated in the control unit (cf. FIG. 2) of the robot 100. In this case, for example, while the map is being compiled, the position of the robot 100 in this map is simultaneously and continuously determined, based on the movement of the robot (in particular, odometry measurements) and on the explored (and therefore known) parts of the map (deployment area) that the robot has already travelled through, by means of a SLAM (simultaneous localization and mapping) procedure. A continuous tracking of the robot while a new map is being compiled, as described here, is not to be confused with the aforementioned self-localization in an already existing map (carried out without available data regarding the position of the robot).

The exploration run can last as long as it takes to complete the map. This will be the case, for example, when the surfaces accessible to the robot are completely surrounded by obstacles (cf. FIG. 4). Alternatively or additionally it can be determined whether new orientation data is available and whether the orientation data already collected is known with a satisfying degree of accuracy. The degree of accuracy can be determined, for example, on the basis of the detected probabilities, variations and/or correlations employing a probability SLAM procedure.

There are various possible navigation strategies that can be applied during the exploration run, all of which to a large extent depend on the sensor system used. For example, the entire surface can be travelled over, which is particularly suited when short-range sensors for detecting obstacles are used (with a range of, e.g. less than 10 cm or less than 1 m). For example, the deployment area may be traveled over until its entire area has been covered by a long-range sensor (e.g. with a range longer than 1 m). Rooms and the entrance ways of doors, for example, can thus be detected during the exploration run and the exploration can be continued room for room. In the process, one room is entirely examined before the exploration of the following room begins.

The diagrams in FIG. 6 exemplarily illustrate how an autonomous mobile robot 100 explores its environment. In the example illustrated in diagram (a) of FIG. 6, the sensor unit 120 of the robot 100 (see FIG. 2) comprises a navigation sensor 121, which covers a defined range of detection (coverage area) Z. In the example shown here, the coverage area Z has the approximate shape of a circle sector with the radius d. The navigation sensor 121 is configured to detect object (e.g. obstacles, furniture and other objects) in the environment of the robot 100 by measuring the distance to the contour of an object as soon as the object enters the coverage area Z of the sensor 121. The coverage area Z moves together with the robot and the coverage area Z may overlap an object when the robot comes closer to it than the distance d. FIG. 6, diagram (b) shows a situation in which an obstacle H is located within the coverage area Z of the robot's navigation sensor 121. The robot can already identify part of the contour of the obstacle H, in this case that is the line L on the side of the obstacle H that faces the sensor 121. The position of this line L can be recorded in the map. As the exploration run proceeds the robot will detect the obstacle H from additional viewing directions, adding these until the complete contour of the obstacle H is recorded in the map.

In the example illustrated in FIG. 6, the coverage area Z of the sensor system has a comparatively narrow range. There are sensors, however, that are capable of covering a range of 360°. The coverage area Z of such sensors thus has the shape of a (perfect) circle. Further variations in coverage area are possible using different commonly known sensors. The coverage area, for example, of sensors intended for three-dimensional scanning of the environment can be defined by a volume, for example, as an orifice cone. In addition to this, when the sensor is mounted on an actuator (in particular, on an engine), the coverage area can move relative to the robot, enabling the robot to “see” in different directions.

The coverage area Z is not just an equivalent of the scanning range of the sensor, but is also a product of the desired degree of measurement accuracy. For example, in the case of triangulation sensors, as the measured distance increases, the measurement also becomes increasingly inaccurate. Likewise, ultrasonic sensors can only reliably detect structures in the environment when they are moved at an appropriate distance to the structures.

The coverage area Z of some sensors may be limited to the current position of the robot. Common floor sensors, for example, for recognizing a dangerous ledge (for example, a step), are directed below or at the floor immediately before the robot, meaning that the coverage area does not extend beyond the position of the robot. A further example is the detection of a change in floor covering. Such a transition can be detected, for example, based on a brief change in position (e.g. occurring upon travelling over the edge of a carpet) and/or a change in the movement behavior (e.g. resulting from drifting and slipping on a carpet or a rough surface) detected during the run. As a further example, there are also obstacles that the robot can only detect upon contact, by means of a tactile sensor such as, e.g. a contact switch (e.g. obstacles that are difficult to detect with visual means, such as glass doors).

The coverage area Z can generally be described, depending on the employed sensor and it arrangement on the robot, by one or more points, a line, a surface area or a volume, arranged in an appropriate manner in relation to the robot.

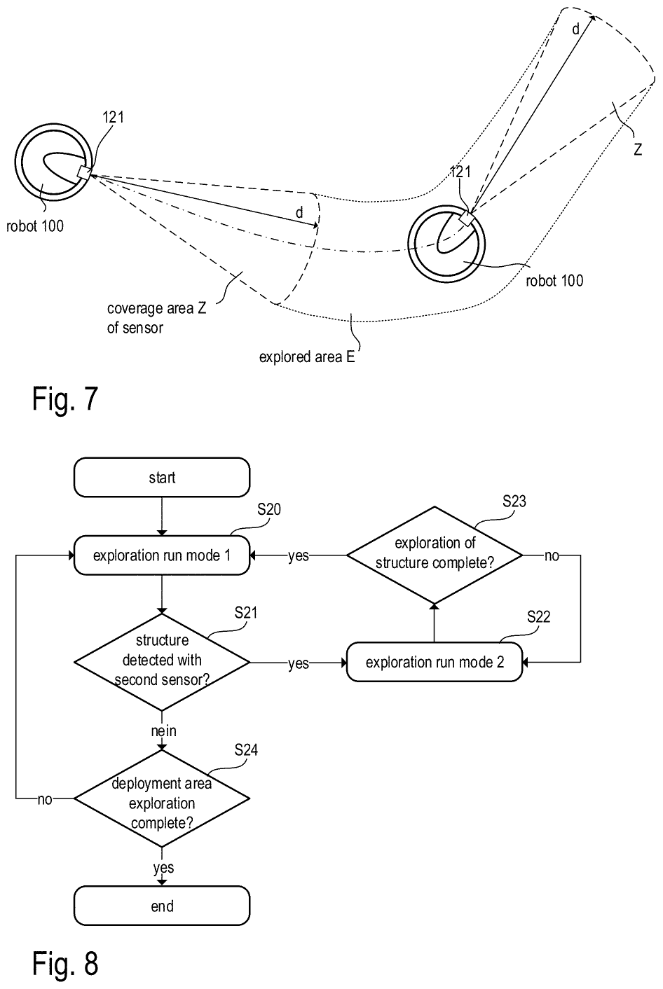

As shown in FIG. 7, the coverage area Z can be marked in the map as “explored”. This means that the robot “knows” what parts of the deployment area it has already examined and subsequently mapped. In the example illustrated in FIG. 7, the explored area E encompasses all points of the robot deployment area that were located within the coverage area Z at least once during the exploration run as it moved together with the robot 100. The explored/examined area E thus represents, so to speak, the “track” of the sensor's coverage area E. The parts of the map that are not marked as having been explored may be regarded as “blank spaces”, about which the robot does not (yet) have any information. It should be noted here that an object H located in the coverage area Z also shadows a portion of the coverage area and effectively makes it smaller (see diagram (b) in FIG. 6). Further, when implemented in practice the opening angle of the field of vision of a sensor is often much wider than shown in FIG. 7.

Far-field and Near-field Exploration—As described above, commonplace service robots for household use generally have a few short range sensors that can detect structures in the environment such as, e.g. the borders of floor coverings or dangerous ledges, only when travelling over them or shortly beforehand. The coverage area Z of such short range sensors roughly corresponds to the size of the robot, which why, in most cases, the entire deployment area has to be travelled over during an exploration run in order to detect all of the structures. This takes a great deal of time and increases the risk of the exploration run being unexpectedly disturbed or interrupted (e.g. by navigation problems or by user intervention).

These problems are mitigated when the robot carries out the exploration using a long range sensor with its correspondingly expansive coverage area Z (cf. FIG. 6). In this case the entire surface of the deployment area does not have to be travelled over because the relevant orientation data can be collected from a few chosen areas, which significantly shortens the time needed for the exploration. This also allows the robot to keep a safe distance to areas in which navigation problem might arise (e.g. the close proximity to an obstacle). One possible disadvantage of this approach is that some structures in the environment, in particular, structures that can only be recognized when the robot closely approaches or travels over them, will be overlooked.

In order quickly complete the exploration while still detecting all relevant structures, the robot can combine two strategies. In a first operating mode (in which a first exploration strategy is employed), the environment is examined using at least one first sensor that has a first coverage area Z1, generally using a long-range sensor. The exploration strategy employed in the first operation mode may be designed to explore the deployment area as quickly and efficiently as possible. The sensor used in this case will be, for example, a sensor for the contactless measurement of distances over a long range such as, for example, an optical triangulation sensor, a laser scanner, a so-called “range finder”, a stereo camera or a ToF (time of flight) camera. As an alternative or in addition, the first sensor may also be a simple camera and the images it records, or the navigation features extracted from these images, can be used to map the deployment area.

Generally, in this first operating mode the robot will also gather data using a second, short-range sensor that has a second coverage area Z2 (e.g. a floor sensor for measuring the distance to the floor and for detecting ledges or steps, a sensor for detecting the borders of floor coverings, and/or a contact switch for detecting “invisible” obstacles such as, for example, glass doors). A similar short-range sensor only detects, for example, structures in the environment when the robot moves into their immediate proximity (e.g. as in the case of a dangerous ledge) or when it travels over them (e.g. as in the case of a floor covering border). Examples of this include: detecting impacts, gathering data regarding a floor covering and/or changes in the floor covering (floor covering border), detecting a dangerous ledge under or immediately in front of the robot, detecting obstacles using a short-range proximity sensor or recording images of the floor surface underneath the robot or in its direct environment.

In a second operational modus the robot may then employ a second exploration strategy to examine the specific structures using a short-range sensor. This is carried out, for example, by following the course of the structure through the room. Operating in this manner is particularly advantageous for the mapping of line-shaped structures such as the borders between floor coverings or ledges and steps.

Generally, the two coverage areas Z1 and Z2 will be, at least partially, disjunctive, meaning they will not overlap or will do so only partially. The two coverage areas Z1 and Z2 are then combined, using both of the described exploration strategies (operational modes), in order to compile a map that contains all of the essential structures of the environment, thus eliminating the necessity of travelling over the entire surface of the deployment area.

The change from the first mode of operation into the second mode may take place automatically, for example, if a relevant structure is detected in the first mode with the second sensor (see also FIG. 8). When started, the robot explores, in step S20, the environment in the first modus of operation (Modus I) by carrying out measurements with a long-range first sensor that can detect a first type of structures such as, e.g. the geometric structure of the environment in the deployment area (i.e. objects designated as obstacles such as walls, doors, furniture, etc.). If, in the subsequent step S21, the examination reveals that a structure of the second type has been discovered (e.g. the border of a floor covering, a door sill, a step, etc.), the robot changes to the second modus of operation (Modus 2). In step S22 the detected second structure is explored until a test (step S23) confirms that it has been completely examined. After this, the robot continues examining the geometric structure of the environment in the first mode (step S20). This is continued until a test confirms (step S24) that the entire deployment area has been examined. The exploration run is now finished and the robot, for example, returns to its starting point.

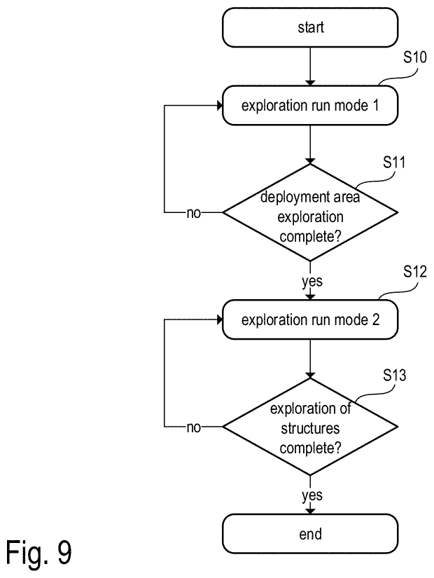

Alternatively or additionally, exploration in the first mode may be continued until either a suitable subarea (e.g. a room), or the entire deployment area, has been examined (cf. FIG. 9). After being started the robot examines the environment, in step S10, in the first mode, carrying out measurements with a long-range first sensor. In this step the positions of the structures detected by the short-range second sensor can be recorded in the map. The robot, however, does not occupy itself further with these structures. In step S11 the robot verifies whether the exploration (of a room or of the entire deployment area) has been completed. If not, the exploration is continued in the first mode I (step S10). After the exploration in the first mode is completed, the robot continues the exploration, in step S12, in the second mode. The robot moves, for example, to the positions recorded in the first mode at which the second sensor had detected a structure. Starting from this position, the robot first examines this structure in its entirety, in the case of an edge or the border of a floor covering, for example, by attempting to follow it. After it has been confirmed, in step S13, that all of the detected structures have been completely examined, the exploration run is ended and the robot, for example, returns to its starting position.

The methods described here can be combined and further developed to meet the requirements of other sensors (and other modes of operation). For example, it is possible to change immediately from the first mode to the second mode when a dangerous ledge is discovered in order to appropriately delineate the region in the deployment area. In the case of a detected floor covering border, for example, exploration can be continued in the first mode until it has been completed. Afterwards, the borders between the floor coverings can be completed by adding the data from the known map. In other words, the approaches illustrated in FIGS. 8 and 9 can be combined.

Additionally, hypotheses can be formulated in the second mode about the contours of the structure in the environment that was detected by the second sensor. One such hypothesis would be, for example, that a carpet has a rectangular shape. The carpet may be lying apart in the room, for example, or it may extend adjacent to an obstacle (e.g. a wall, a piece of furniture). Commonplace alternative carpet shapes include circles, ovals and wedge shaped carpets. There are also carpets (such as an animal fur) that have an irregular shape. These hypotheses can be specifically tested in the second mode by first calculating a hypothesis based on a sensor measurement taken at a specific position and then moving to this position to test the hypothesis. For example, when a hypothesis is posited that a carpet is rectangular the assumed position of the carpet's corners can be computed and the robot can travel to these positions to either confirm or reject the hypothesis. Once a hypothesis concerning the shape of a carpet has been confirmed, the corresponding floor covering border can be entered into the map, without the need for the robot to explore the entire border of the carpet. If the hypothesis is rejected, a new hypothesis can be posited and tested or the robot can follow the border between the floor coverings until it has been completely examined.

In a further example, the hypothesis concerns the progression of a door sill or of a floor covering border that lies in a door. As a rule, both will extend in a straight line between the door frame, often following the progression of a wall. This hypothesis can be tested, for example, when the robot once again leaves through the door in question after having completely explored a room.

One advantage entailed in the positing of hypothesis is that it reduces the frequency with which the robot has to travel to a position and examine a structure in its entirety with the second sensor in order to map it. When a test reveals that a hypotheses is true it is no longer necessary to explore and examine the entire structure. For example, in the case of a rectangular carpet, the robot can travel to the four points where the corners would be. If the corners are revealed to be there where they are assumed to be, exploring the rest of the carpet is no longer needed. This reduces the time needed to complete an exploration run and increases the robot's efficiency.

While in the first modus (exploration strategy), small structures such as, for example, a small carpet with thin carpet edges, may be overlooked as a border between floor coverings if the robot does not travel over it. The typical relevant structures found in a living environment, however, have typical dimensions (e.g. 2 m). Care can be taken while carrying out the exploration in the first mode to ensure that the robot comes close to every accessible point in the deployment area at least once—coming close here means approaching the structure at a specifiable minimal distance (e.g. 1 m). This ensures that the existence of structures, the typical size of which equal twice that of the specified distance, will be reliably detected by the second sensor and not overlooked.

The aforementioned can be achieved by recording the path the robot has already travelled in the first mode. Alternatively or additionally, after completing the exploration in the first mode, the robot can return to every point that it did not move close enough to while exploring in the first mode. An alternative further possibility for the robot to move into close proximity of all accessible points in the deployment area is to virtually downscale the coverage area Z1 which, for example, can be achieved with a corresponding programming of the control unit 150 (e.g. of the navigation module 152). The result of this is that the robot will move even closer to the points of the deployment area than theoretically needed, in order to then mark them as an explored area E (cf. FIG. 7). Additionally or alternatively, a position at an appropriate distance can be determined (based on the typical size of the structures to be detected), and the robot can move to this point in order to detect any potentially existing structures and then to examine them further in the second mode.

Continuation of an Exploration after Interruption—During an exploration run, numerous problems may arise that can hinder the navigation and/or movement of an autonomous mobile robot. For example, extensive slipping may occur when the robot travels over a door sill, which can disrupt the odometry and make it difficult to reliably determine the position of the robot. Loose cables lying about on a floor, for example, may also hinder the robot's progression. It may even happen that the robot becomes stuck and unable to continue its run. In such cases, the mapping can be suspended (interrupted), for example, until either the robot is able to free itself or a user can come to free the robot. Afterwards, as soon as the robot is once again capable of reliably determining its position, the exploration run for compiling the map should be continued. This prevents the map from having to be newly compiled from the beginning and it increases both the reliability, as well as the efficiency of the robot.

Two technical problems may arise in this context. First, it may happen that the robot once again becomes stuck in the same area, which can again delay the map compilation or even render it impossible. Furthermore, it may happen that the navigation or movement problem is recognized too late to interrupt the map compilation in time. In the span of time between the occurrence of the problem and it recognition by the robot, incorrect map data may be recorded if the robot, for example, fails to accurately determine its position and enters the detected environment data, in particular, the orientation data (e.g. regarding obstacles, landmarks, etc.) at the wrong position in the map. Such errors can be tolerated when they occur in the temporarily saved map (which is compiled anew for every deployment) as the errors in this map have no effect on subsequent deployments. Similar inaccuracies in the permanently saved map, however, can seriously impede the functioning of the robot, leading to systematic errors that can befall the processing of the robot's tasks in every subsequent deployment.

Thus a method is needed that not only makes it possible to continue the exploration and map compilation after a navigation or movement problem of the robot arises, but that also enables the robot to handle the navigation and/or movement problem robustly, meaning without allowing the problems to cause errors in the compilation of the map. This can be achieve, for example, by determining the exact time and/or place (problem area) at which the problem arose. Starting from here, erroneously recorded data can be deleted and/or the problem area can be excluded from further navigation.

Here it should be noted that, in some cases, it is very easy to locate the place at which the problem arose. When this is the case, the problem area can be reduced to a point on the map. Often, however, it is not easy to precisely identify the problem's location and/or the problem affects a larger area. In this case the problem area may be defined by a surface area or subarea.

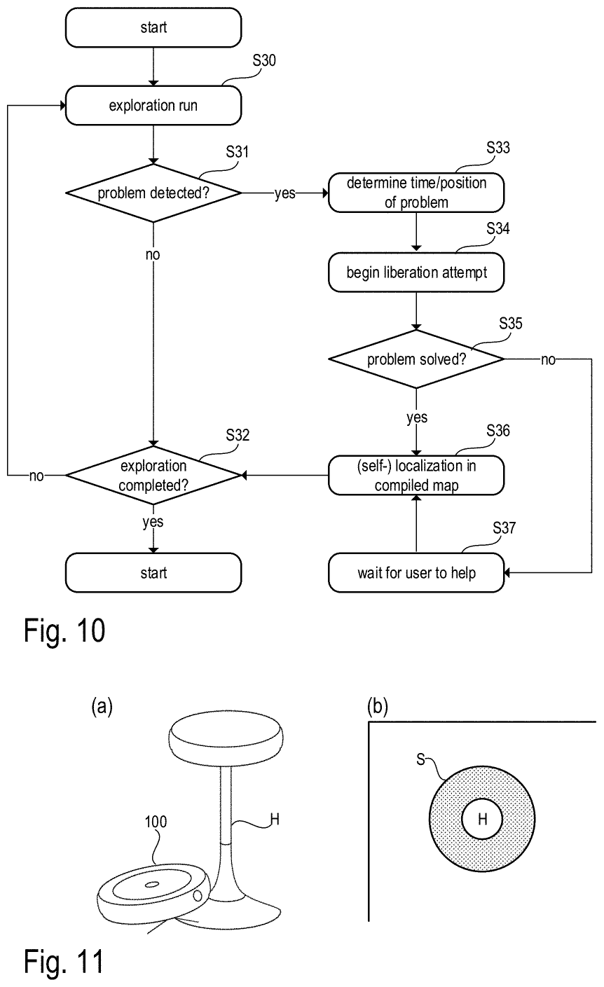

FIG. 10 shows an example of a possible approach to exploring an area of deployment. After starting the robot, the deployment area is systematically explored (see FIG. 10, step S30). For this, one of the previously described methods may be used, for example. Alternatively, the robot could also travel over the entire surface or a different suitable method for exploring the robot deployment area could be employed. As long as no problem arises (a navigation or movement problem, see FIG. 10, step S31), the exploration run is continued until the entire deployment area has been examined (FIG. 10, step S32). Once it has been confirmed that the deployment area has been fully explored (FIG. 10, step 32), meaning, for example, that there are no accessible areas left that the robot has not explored and/or the deployment area recorded in the map is completely surrounded by obstacles, the exploration run is ended. The robot can now return to its starting position or to the base station and can save the compiled map as a permanent map to use in following deployments and for interaction with the user.

As described above, numerous problems may arise during exploration that can be recognized by the robot (FIG. 10, step S31). For example, the robot may plan a particular movement and then attempt to carry it out (under the control of the drive unit 170). If the drive unit 170 is blocked, for example, then the robot will not be able to carry out the movement. It may then be determined using, for example, an odometer and/or inertia sensors, that no movement has taken place. Alternatively or additionally, a problem may be detected based on the power consumption of the drive unit. For example, if the problem involves the robot getting stuck, the power consumption of the drive unit will be exceptionally high.

A similar problem may arise involving the slipping or idle running of the wheels, which can also make a controlled movement difficult or even impossible to carry out. Slipping may occur, for example, when the robot travels over a step or ledge, as well as when the robot gets stuck by an obstacle such as loosely lying cables (for example, the electric cord of a standing lamp). Considerable drifting (i.e. an uncontrolled sideward movement) can also occur when the robot moves over cables, steps or ledges. The robot (in particular the drive unit) may lose contact with the underlying floor surface while trying to travel over cables, steps or ledges, also hindering or altogether preventing further movement. In a worst case scenario the robot will be stuck on the obstacle without any traction left at all.

One further example for an uncontrolled movement (i.e. one not initiated by the robot) is an external impact to the robot, e.g. a force exerted, for example, by a person or house pet who (that), confronted by a new unknown robot, will want to engage, perhaps even play with it. It may happen, for example, that the robot is lifted, picked up or even “kidnapped”—carried to a different location, all of which also results in the robot partially or entirely losing contact with the floor surface.

A further problem may involve the robot getting locked in somewhere. For example, while the robot is exploring a room, the door may be closed or fall shut. In a further example, the robot may travel under the sofa and cause the sofa cover to slip down. The cover is perceived by the robot to be an obstacle and it can no longer move from under the sofa without colliding into an obstacle. Still further, erroneous measurements of a sensor caused, for example, by mirroring by create the illusion of an obstacle where there is none and the robot's path (in the map) will apparently be blocked. An indication of this problem may be that the robot can no longer plan a path from its present position into a further mapped area (in particular, to the starting point of the robot) due to the obstacle now recorded in the map.

All these problems can make it difficult or even impossible to know the exact position of the robot and/or to compile a usable map. In such a case, the map compilation, for example, can be suspended or interrupted when a similar problem is detected (FIG. 10, step S31).

In some cases a problem is not immediately recognized (e.g. if there is no sensor capable of doing so or in the case of smaller, frequently occurring disturbances), leading to the compilation of an inaccurate map. Such errors frequently result in inconsistent map data that does not describe the real environment. When such inconsistencies are recognized, it again may be concluded that a navigation or movement problem has arisen. One such inconsistency may be apparent, for example, if an obstacle is recorded in the map more than once (e.g. overlapping or immediately following itself) and it cannot be associated with an obstacle that has already been mapped. It may also happen that an obstacle can be associated with a mapped obstacle, but the position in the map significantly and repeatedly diverges from the detected position. Finally, it may also be possible to recognize an inconsistency in that a newly mapped navigation feature (see orientation data 505, FIG. 4) is revealed to be “incompatible” with a navigation feature already recorded in the map (i.e. the newly mapped and the already present orientation data is contradictory and mutually exclusive).

In some cases, the robot can independently (without the intervention of the user) continue the exploration run after it solves the problem. There is still a risk, however, of the problem arising again and/or of inaccurate map date being generated while the problem still persists. In order to avoid these risks, the robot can try to narrow down the place and/or the time point at which the problem occurred, for example (FIG. 10, step S33). If the problem is easily detected by a sensor (e.g. in the case of an impact, by an acceleration sensor), the point in time at which the impact was detected TP1 and the position of the robot at this point in time TPI can be utilized for this. Additionally or alternatively, a further point in time TP2 that lies over a specifiable time span before the point in time of the detection TP1 can be used. This makes it possible to take into account delays in detecting problems.

The robot's position at the point in time TP2 can also be used to determine the problem area. Alternatively or additionally, the last position that can be determined with a specifiable degree of certainty can be used. A value for the degree of accuracy/certainty of a position can generally be generated using a SLAM procedure and it is lowered if unknown or inaccurate measurements are produced. In order to narrow down the problem area, these positions can be connected together. Additionally, an area surrounding these positions can be marked as a problem area, for example, an area of the same size as the robot.

Additionally or alternatively, the area can be determined by means of a map analysis (e.g. an analysis of the logical inconsistency of the map data). In this way, the position of inconsistent data can be determined. Starting from here, for example, the time point at which the data was detected can be determined. For this purpose, for example, every map entry can be provided with one or more time stamps showing, e.g. when the entry was made and/or when it was last confirmed by further measurements. For example, every point in time at which a map entry was measured, or the frequency with which the entry was measured, can be saved along with the respective entry. Based on the point in time, the position that the robot was at when it recorded the data can be determined, as described above. If, for example, an analysis reveals that an obstacle has been entered into the map more than once, the point in time at which the first entry was made, and/or the point in time of the previous entry, can be utilized. As an alternative or addition to this, an area can be determined in which the date can be detected.

If the robot was locked in a subarea, this subarea can be marked as a problem area.

The robot has numerous strategies that it can apply to extract itself out of many of the navigation and movement problems (FIG. 10, step S34). If, for example, the robot travels over a low lying obstacle (e.g. a cable, a step or a ledge) and loses the contact with the floor, it can avoid getting stuck by immediately reversing its direction of movement to pull back from the obstacle. If the robot nevertheless becomes stuck, it can attempt to free itself by make short, jerking backwards movements. If the robot becomes (apparently) locked in in a subarea, it can move about the subarea and attempt to find an exit by touch. This frequently helps to solve the problem, in particular when it stems from inaccurate measurements (caused, for example, by reflections that can corrupt the distance measurements of a triangulation sensor).

Once the robot has successfully solved the problem (FIG. 10, step S35), it can (again) determine its position in the at least partially compiled map (FIG. 10, step S36). In some situations, if, for example, after successfully freeing itself the robot cannot determine its position with sufficient accuracy, the existing localization carried out with the SLAM algorithm may suffice.

Alternatively, a global self-localization may also be carried out. This makes it possible to determine the position of the robot with much more accuracy and map errors caused by an inaccurate or false estimate of the robot's position made using the SLAM algorithm can be avoided. A global self-localization, however, demands quite a bit of time and computational effort, which must be weighed against the potential benefits of using this method. The severity of the problem can be considered when deciding whether a SLAM procedure will suffice or whether a global self-localization should be carried out.

The global self-localization can make use of the previously known fact that the robot, after successfully liberating itself, will still be located in the immediate proximity of the problem area. Thus the robot can be directed away from the problem area, for example. Furthermore, the solution space (i.e. the part of the map in which the attempt is made to localize the robot) can be reasonably narrowed down by making use of this prior knowledge. As an alternative or addition to this, the position of the problem area can be determined or further narrowed down based on the results of the global self-localization, as the robot will still be located in the close proximity of the problem area when starting the global self-localization, immediately after having successfully freed itself from the obstacle.

In some case, the liberatory maneuver (FIG. 10, step S34) does not result in a solution to the problem. This is determined to be so, for example, if, after a given time, the problem persists (FIG. 10, step S35). In this case the robot stands still and waits for help from the user (FIG. 10, step S37). The robot signals that it needs help by emitting acoustic and/or visual signals that emanate directly from the robot, for example. Alternatively or additionally, the user can be informed that the robot needs attention by means of a message sent to the external HMI 200 (cf. FIG. 2).

The user can now liberate the robot and solve the problem. Generally the user will pick up the robot and carry it to a new location. Here the robot may begin a global self-localization (FIG. 10, step S36), wherein the robot can determine its position relative to the already (partially) compiled map 500. The methods used for this are commonly known. For example, the robot may compile a new (temporary) map 501 and search for matches to the previously compiled map 500. If the matches are sufficiently definitive, the data from the temporary map 501 can be incorporated into the map 500 and the exploration run may be continued.

Alternatively or additionally, a message may be sent to the user (e.g. to the HMI 200), requesting that the robot be brought to a given location (a position already recorded in the map). This may be, for example, the starting position of the robot or a position nearby. In particular, the starting position may be the base station 110. If the robot is returned to the base station 110 and the position of the base station is already recorded in the map, then, as an alternative, the global self-localization may be omitted, for example. Alternatively or additionally, the user may also inform the robot, via the HMI, of the location in the map at which the problem arose. If needed, the user may define an exclusion zone that surrounds this location before the robot carries on with the exploration.

It should be noted that determining the problem area and/or the time point at which the problem arose (FIG. 10, step S33) need not always follow immediately after detecting the problem (FIG. 10, step S31). It can just as easily be carried out, for example, after an attempted liberatory maneuver (S34), after the self-localization (S36) or at any other suitable time. The user may also be requested, for example, to mark or confirm the problem area in a (partially compiled) map displayed on the HMI 200.

Knowing where the problem area lies and/or at what point in time the problem arose can be of good use for the compilation of the map and for the continued exploration of the deployment area (S30). The cause of the problem, (if it is apparent upon its detection), can be added to the data on the problem area that are saved. This information (e.g. unusually high slippage, robot immobilized) can then later be taken into consideration when the problem area is dealt with.

The problem area may be closed off for further access by the robot, for example, which will reliably ensure that the problem will be avoided. Alternatively, the area can be marked with an attribute such as “difficult to move through” or “avoid”. The robot can take such attributes into consideration during navigation and the robot can attempt to steer around the respective area whenever possible. As opposed to a completely prohibited area (virtual exclusion zone), the robot can travel through an area marked with the attribute “avoid” if this is needed, for example, in order to conclude the exploration.

Some objects such as, for example, chair or table legs, stools and other furniture, have non-standard geometric shapes. The legs of tables, chairs or barstools, for example, may have pronounced curvatures that can create unexpected problems for navigation and the robot's movement. The robot may become upended when it moves onto a wide pedestal that curves flatly upward (as is found in many barstools and couch tables) and thus lose contact with the floor, for example. Legs that extend at an incline to each other, for example, may approach each other so narrowly toward their ends that the robot becomes stuck between them, even though its sensors indicated that there was sufficient room for navigation.

FIG. 11 exemplarily illustrates in a diagram (a) a navigation/movement problem that a barstool H (or a similar piece of furniture, e.g. a table) poses for the robot, as well as the associated problem area S (see FIG. 11, diagram (b)). Since such problems, or better put, such furniture, if at all present in a household, is usually found more than once, it may be attempted to associate the navigation/movement problem and its associated problem area with an object that can be recognized by the robot and/or a pattern that can be recognized by the robot. In the example illustrated in FIG. 11 it is the specific radius of the pedestal/leg of the barstool that can be identified by the robot. For this purpose, the already compiled map and, in particular, the sensor measurements taken in the vicinity of the problem area can be analyzed. If this object or pattern is again discovered, the robot can maintain a safe distance to it. For example, an area S around the object or pattern can be marked as “do not enter” or “to be avoided”. The area can be determined based on the identified problem area or, as an alternative, it can be given a simple basic shape (e.g. a circle).

Before a problem is detected, erroneous map data may be generated, for example. Taking into consideration the problem area may entail, for example, the deletion and/or correction of map data that are based, entirely or partially, on measurements taken in the problem area and/or following the point in time at which the problem was detected. The subarea can then be once again explored when the exploration run is continued (while taking into consideration the attributes assigned to the problem area, such as “do not enter” or “to be avoided”).

As an alternative, instead of deleting the map data, the problem area may again be explored. For example, the robot may recognize (as described above) that it is locked in in a given area, e.g. due to a door falling shut. In this case the robot would notify the user via the HMI 200 so that door, and with it the robot's path, can be opened, thus liberating the robot. Afterwards the user can tell the robot via the HMI 200 to carry on with the exploration. In such a case it may be useful for the problem area (that is, the room) to be, entirely or partially, explored again. The doorway (of the reopened door), for example, can now be recognized as freely accessible. The renewed exploration of the problem area may start from its edge or even be limited to its edge (e.g. locating and identifying the doorway).

When the user liberates the robot, the user can, if needed, also remedy the underlying problem. For example, lose lying cables may be otherwise arranged so as not to hinder the robot in future. For example, if chairs or stools were the source of the problem, the user can place them on a table so that, at least for the time being, they no longer present an obstacle for the robot. Other problems such as table legs, however, cannot simply be done away with.

One possible way of recording the behavior and intentions of the user is to send the user a corresponding question, e.g. via the HMI 200. The robot can wait, e.g. for a user input as to whether the navigation or movement problem has been permanently or only temporarily remedied, or whether the robot is expected to deal with the problem. How the problem area is taken into account may depend, for example, on this user input. If the problem has been permanently remedied, the problem area may once again be explored and then “forgotten” (not saved). If the problem has only been temporarily solved, the problem area may once again be explored and the robot may additionally suggest to the user (by means of the HMI 200) that a subarea be created in this area that is generally excluded from further autonomous access by the robot. If needed (e.g. after the user has put the problematic chairs out of the way), the user can specifically send the robot into this area (e.g. to carry out a cleaning). If the robot is required to deal with the problem itself, it can create an exclusion zone based on the identified problem area. The problem area can be shown to the user. In addition, it is also possible to wait for a confirmation by the user.

Renewed Exploration of a Mapped Area (Re-Exploration)—A further problem that arises with permanently saved maps is how to deal with changes in the environment. Such changes may be permanent or temporary, but which of them are permanent or only temporary is often difficult for the robot to discern. Generally, it is attempted to handle this problem using complex statistical models that enable the robot to “learn more” over time.

In the process, however, a great deal of data will be gathered that may negatively influence the robot's navigation and efficiency. It may therefore be useful to explore the deployment area repeatedly in regular intervals (or after larger changes to the map, for example). A renewed exploration of the deployment area and the subsequent renewed compilation of the map would, however, result in the loss of a large amount of metadata that the robot had learned over time or that the user had entered (e.g. the partitioning of rooms, the designation of room, the frequency with which an area becomes soiled, etc.). The user may also find it very irritating to have to repeatedly enter lost information. In order to improve this situation, a method is needed with which the orientation data 505 of the map 500 can be reliably updated without losing the metadata 510 in the map (in particular, the data entered by the user).

The aforementioned problem can be solved, for example, in that the user initiates a new exploration run of the robot through the entire deployment area or a part thereof, and in that the robot, while carrying out the exploration, makes use of the already existing permanently saved map. If required, the robot can call the user's attention to the fact that the area to be newly explored has to be cleared of obstacles, at least to the extent so as not to hinder the navigation of the robot and to allow for the compilation of a map that is as accurate as possible. After this, the robot can begin its exploration of the assigned part of the deployment area, during which information regarding the structures in the environment of the robot in the deployment area is gathered by means of the sensors in the sensor unit 120 and the differences between the orientation data already saved in the map and the data gathered by the sensors of the sensor unit are analyzed.

In this manner, the robot can compile an updated map 502 of the deployment area. For example, based on the (orientation) data gathered by the sensors, the robot can recognize an object that is not yet recorded in the map, or an object that is recorded in the map but which is no longer present (because the sensors no longer provide the corresponding orientation data). The robot is also capable of recognizing when an object has been relocated and can adapt the orientation data saved in the map to the new location. This approach has the advantage of allowing metadata to be easily included into the updated map and thus prevents it from being lost. In a less sophisticated approach, in which a new map is simply compiled, without taking into account the old map, this is not the case and the metadata is lost. The thus updated map 502 may now be permanently saved and used in further deployments of the robot for navigation and for interaction with the user. This makes it possible to completely replace the previously saved map 500. Additionally or alternatively, a backup of the map 500 can be retained. This can be stored, for example, on an external device 300 (e.g. a cloud server).

The renewed exploration requested by the user may encompass the entire deployment area or only part of the deployment area. The user can stipulate this to the robot via the HMI 200, for example (e.g. by means of a command entered over the HMI). For example, the exploration may be limited to one room, in which case the user may select the room, for example, in a map displayed on the HMI or by entering the name of the room. The user may also, for example, mark an area that is to be newly explored on the map displayed on the HMI 200.

During exploration the robot can move through the part of the deployment area that is to be examined in a manner that ensures that this part is entirely covered by the sensor (or sensors) contained in the sensor unit. In addition to this, the measurement accuracy with which the data is detected can also be varied. In this way, identified changes to the deployment area can be examined more closely, while the unchanged parts of the deployment area can be examined with less measuring precision. Possible strategies for this will be detailed further below. The degree of measuring precision can be raised by any of the following means: increasing the time spent in the given area, moving closer to the examined obstacle, enlarging the area covered by the robot during exploration, increasing the testing duration, reducing the speed of travel.

When the user requests that a renewed exploration be only performed in a subarea (e.g. in a room), only the changes that have been identified in this subarea or room need be taken into account for the compilation of the updated map. This means that, while moving toward the subarea to be newly explored, any detected discrepancies between the map and the actual environment (as seen by the sensors) will be ignored. This means that the user only needs to prepare (tidy up) the subarea intended for renewed exploration for the exploration.

It is also possible that the deployment area has been expanded beyond the original map 500. In this case care has to be taken to ensure that the updated map completely reflects this expansion in order that a finished map be compiled.

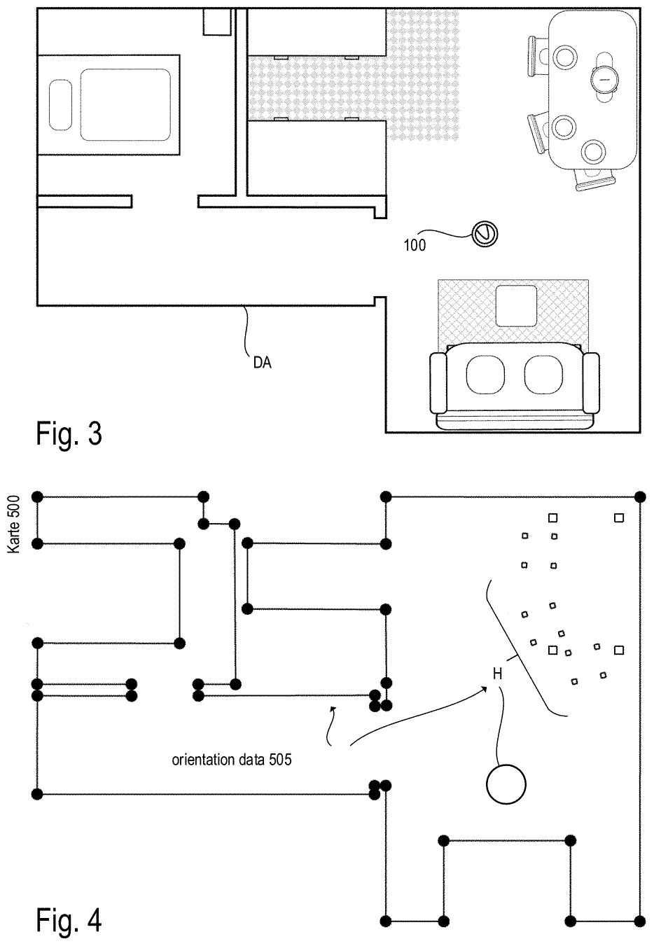

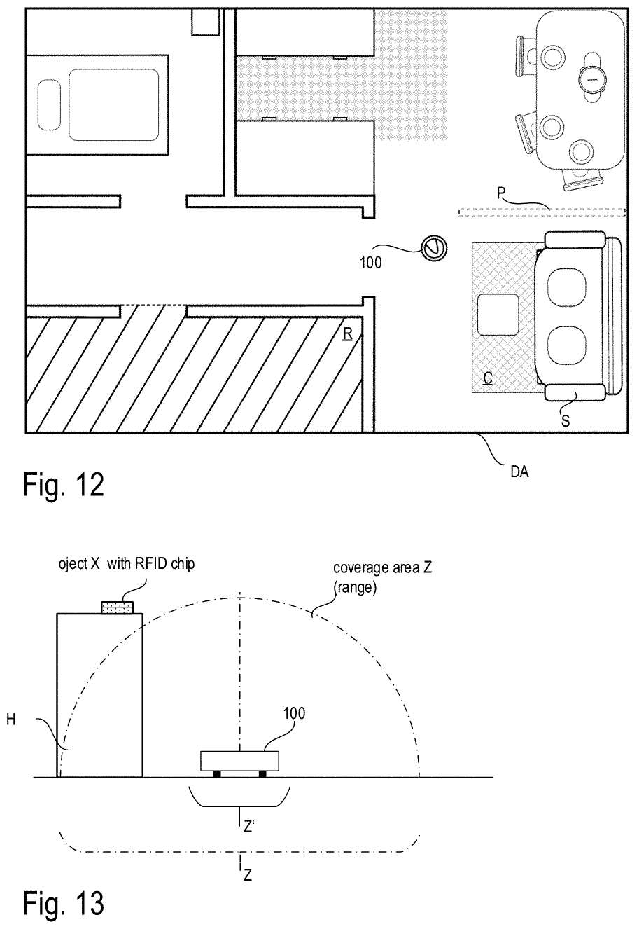

In general, the deployment area covered by a new exploration run may be larger or smaller (or larger in one region and smaller in another) than the area recorded in the map 500. Common causes of this can include the addition of new furniture (the deployment area is restricted), the removal of furniture (the deployment area is expanded) or the relocation of furniture (the deployment area is expanded in one region and is restricted in another). Additionally or alternatively, the user may decide, for example, to open up a room for the robot to enter that was not previously mapped. FIG. 12 shows, for example, a possible change to the deployment area illustrated in FIG. 3. Here the couch S and the carpet C lying before it have been rearranged and a new room R has been opened up for the robot 100 to access. This necessitates the adaptation of at least a portion of the metadata, for which the changes to the deployment area have to be detected and analyzed.

In order to compile the updated map 502, the changes to the deployment area in comparison to the point in time at which the already existing map 500 was compiled can be determined. For this, in particular the data regarding the structure of the environment that was recorded during the exploration and saved in a new temporary map and the orientation data contained in the existing map 500 (e.g. detected walls, obstacles and other landmarks) are compared. Alternatively or additionally, at the beginning of the exploration run a copy 501 of the permanently saved map 500 can be generated (in particular in the main memory of the processor 155), wherein the robot 100 determines its position in the copy (e.g. using the base station as a starting point or by means of global self-localization). During the renewed exploration the data in this work copy 501 can be directly updated, in the course of which, in particular, obstacles and/or landmarks no longer present are deleted, new obstacles and/or landmarks are added and recognized obstacles and/or landmarks are confirmed. After completion of the renewed exploration, the thus compiled work copy 501 can be compared to the still existing map 500. Alternatively or additionally, the data intended for deletion or addition can be directly utilized to determine what changes were made. When, for example, a newly identified obstacle is added to the map, the information that this obstacle was newly added can also be recorded (e.g. by marking it with a time stamp).

In addition to this, at least some of the metadata of a changed area must also be updated. This metadata concerns the area in which the autonomous mobile robot is to carry out a service task (e.g. a change in the area to be cleaned, new objects to be examined), as well as the form, size and number of subareas and/or rooms. The scheduling data that was entered for the work planning may also have to be adapted. It may happen, for example, that a newly added room has to be included into the task schedule (e.g. for cleaning or inspection). In addition, the reference value regarding the duration of the planned deployment and/or the surface to be cleaned also have to be adapted to the new information.

Additionally or alternatively, the floor covering of newly added surfaces can also be recorded. This can be carried out, for example, by measuring the floor covering borders and by utilizing the information regarding the floor covering already recorded in the map. It may happen, for example, that a user moves a wardrobe in a room or removes it from the room altogether. This creates a new surface area for the robot to which a floor covering can be assigned. If no floor covering border is detected in this area, the information regarding the floor covering of the surrounding area can be carried over onto the new surface area. If a floor covering border is detected, the floor covering of the new surface area can be automatedly determined or entered by the user. A cleaning program linked to the identified floor covering can then automatically be employed. Additionally or alternatively, a cleaning program specified for the surrounding area can also be carried over from the surrounding area onto the new surface area.

The robot is capable of recognizing, for example, when floor covering borders have been moved, such as in the example from FIG. 12 involving the carpet C. If the dimensions of the carpet C (i.e. length, width and height) have remained unchanged, this information concerning the floor covering can be carried over from the previously existing map 500 into the updated map 502 and only the position data has to be updated. The carpet C may additionally be associated with a subarea created by the user. The position of this subarea can also be automatically updated to the new position of the carpet C, e.g. based on the floor covering borders.

Danger zones linked to obstacles or objects can also be updated, for example. Further, a carpet C such as the one shown in FIG. 12 may also have a wide fringe that could become tangled in a rotating brush during cleaning. To avoid this, this side of the carpet can be marked in the original map 500 to be cleaned only with the brushes turned off. This metadata (e.g. saved in the map as an attribute of the subarea) can also be carried over to the new position of the carpet C. This means that metadata that concern the behavior or operation of the service unit 160 can also be automatically adapted to the updated subarea (which, in this example, is defined by the carpet C).

Updating the metadata can be performed automatically or with the aid of a user. In a one simple version the robot itself can recognize whether, and if so which, metadata needs to be updated. After doing so the robot can send a message to the user and request that the specified data be updated, i.e. adapted to the requirements. As an alternative or addition, the robot can suggest a certain update and send the suggestion to the user for confirmation and/or modification. In particular, the updated map 502 can be sent to the HMI 200 which, for example, can show the metadata that is to be updated to the user, e.g. with a display of the map. The user may then accept, correct or delete the updated data. Alternatively or additionally, the update can be performed completely automatedly without the need for the user to confirm the changes.

Example “New Room”—As shown in FIG. 12, the user may open up access to a new room R for the robot, for example. This new room has not yet been recorded in the permanent map of the robot 100. Since an unmapped area can potentially present a danger for the robot (for example, an open door may lead to an area outside of a home), it is also possible for the robot to ignore a newly (due to the open door) accessible area that is not recorded in the map while carrying out its work tasks.

The robot 100 may carry out a renewed exploration run through the deployment area DA and thereby expand the map such that the room R will be entered into the updated map so that it is taken into account and included in the planning of future deployments. When starting the renewed exploration run, the user can let the entire deployment area DA be newly explored and/or select a subarea for the exploration. For example, the user may send the robot 100 to a point before the opened door to room R. The robot would then begin exploring its environment starting at this point and would immediately recognize that the mapping of the deployment area is not yet complete. The robot recognizes that the room R lying behind the door is an accessible surface and will explore the room R in order to correspondingly expand the map. The new orientation data (i.e. the detected walls, obstacles and other landmarks) that concern the room R (including the information regarding the now open doorway) are then entered into the updated map 502. The remaining orientation data can be carried over unchanged into the updated map.

The metadata can also, for the most part, be carried over unchanged but has to be supplemented with the data regarding the new room R. When doing so, a new subarea that is associated with the room R can be created, for example. This new subarea can be added, for example, to a task plan (e.g. entered into a work schedule). In this way the new room R can be included into the cleaning plan of the entire apartment. The new room R may also be included into the cleaning plan to be cleaned last, for example. Further, objects detected during the exploration run that require examination can be included into an examination run.

Example “Changes to a Room”—In a large room (e.g. in the “living room” of FIG. 12) there may be a partition P (indicated in FIG. 12 by a dashed line) that divides the room into two parts (e.g. a “dining area” and a “living area”). In such a case the robot can clean the two subareas separately (e.g. one after the other). The user may also decide, for example, to remove or shift the partition. In this case the robot would essentially recognize during navigation that the room partition P is missing, but it would continue to clean the two subareas separately. Dividing up the cleaning of a large room into two parts, however, is generally less efficient and the user may find it annoying.

Instead, the user can instruct the robot to again explore only one or both of the subareas “dining area” and “living area”. In the course of the exploration run, or after the renewed exploration, the robot may determine that the user has removed the room partition. The user may further stipulate in a user command that this is not a temporary change, but rather a permanent one. Based on the map data regarding the position of obstacles that was updated during the exploration, the robot can recognize that, due to the fact that the room partition P has been removed, a large open surface has been created that can be efficiently cleaned in one run. Thus the two subareas “dining area” and “living area” can be automatically, or upon request of the user, be joined together into one subarea that encompasses the entire room as “living/dining area”.

If there is a work plan regarding the two subareas “dining area” and “living area”, it can also be automatedly adapted or by sending a message to the user. For example, the schedule may provide for a cleaning of the “living area and a cleaning of the “dining area” to be carried out in the course of a day. These two schedule entries may be deleted and replaced with a single entry for the cleaning of the new subarea “dining and living area”. This will help to make the entire cleaning plan for the day shorter and more efficient.

In addition to this, it is possible to stipulate that the “dining area” be cleaned more often. This parameter, for example, can be included into the task plan recorded in the calendar based on the statistical information regarding the frequency of the cleaning and/or on the average degree of soiling of the area. Further, the subarea “dining area” can be, either automatedly or as a suggestion to the user, retained as an additional subarea that overlaps with the subarea “living/dining area”, for example. This will make it possible to continue cleaning the “dining area” more frequently (manually or started automatedly), while the cleaning of the entire room “living room” (=“living/dining area”) is efficiently adapted to the changed conditions.

Example “New Apartment”—In the following a situation will be considered in which the user has moved into a new apartment. Before arranging the furniture in the apartment, the user has the robot explore the still empty apartment. This enables the robot to compile a very simple map in which the layout of the rooms is easily understood. In addition to this, the user is provided with the exact dimensions of the apartment, which will come in useful when setting up the furniture in the apartment. The user can also compare this information to the information provided by the seller or landlord of the apartment to verify whether it is accurate.

After moving in the user may have the robot explore the apartment again. In this manner the position of the furniture can be entered into the map. The map additionally still contains the previously gathered information regarding the layout of the apartment. The information regarding the accessible surfaces (metadata), however, can now be adapted.

Strategy for Exploration with a Known Map as Search Function—One particular problem that arises when the robot explores an area using a known map, is that the robot has no points of references as to where or how it should look for changes. When a new map is compiled the respective area is explored until the map is completely finished. When carrying out a service task, an update can be carried out during the navigation needed for the task. For example, in passing, the robot may identify a closed door that prevents it from carrying out any tasks in the subarea (e.g. a room) behind the door because this area in inaccessible for the robot. This update is not carried out according to plan but is instead a more spontaneous, incidental update. Therefore a method is needed with which the robot can systematically search for changes in its deployment area that are not in the permanently saved map. Such a search method should similarly be suitable for systematically searching for other events, objects or persons, as well.

The robot already has a suitable sensor for such a search (in the sensor unit 120, cf. FIG. 2) as well as the evaluation algorithms needed to identify the sought after event, object or person. A suitable sensor is, for example, a navigation sensor 121 (see FIG. 6) and/or another sensor for collecting data about the structure of the environment. The sensor(s) can be used by the robot to identify, e.g. the event “Change in Deployment Area”. This is principally carried out by comparing the data collected regarding the structure of the environment in the deployment area with the data saved in the map and, as mentioned above, based on this comparison the map can be updated. When a new area that is not recorded in the map (e.g. a new room) or a new obstacle is discovered, these can be further examined using one of the strategies described above.

In order to identify a specific object, the data regarding the structure of the environment can be searched for a specifiable pattern. In this way, specific objects and/or specially marked objects can be recognized. For example, an object can be recognized by its characteristic shape, in particular, its length, width and/or specific design which can be detected, for example, using distance sensors. The sought after object can also be identified using a camera and object recognition methods. Additionally or alternatively, the sought after object can be marked with a detectable pattern (e.g. a QR code) that can be recognized in the photographs taken by the camera. Additionally or alternatively, the robot may possess a sensor with which it can detect objects marked with RFID chips.

Additionally or alternatively, the robot can be configured to recognize sought after objects or even persons in images. For example, the robot is capable of recognizing the faces of photographed people and can search for people or house pets. The image processing algorithms needed for this are commonly known. People, house pets and certain objects such as, e.g. a hot stove or a burning candle, can alternatively be recognized by their emitted heat emissions. Additionally or alternatively, people, animals or objects can be recognized by the specific three-dimensional form using 3D measurements.

Similarly to the previously described method for exploring a deployment area to compile a map, a coverage area can be assigned to a sensor in which the sought after event or object can be reliably recognized (i.e. detected and localized with a certain degree of accuracy, cf. FIG. 6). An important difference here is that the map is now available and no longer needs to be newly compiled. The coverage area can depend on the type of sought after event or object and, in particular, on the degree of accuracy or resolution needed. If a high degree of accuracy is needed, the robot will generally have to move closer to the event or object to be detected (in the case of a triangulation sensor, for example, the accuracy is reduced as the distance increases). This means that, for a high degree of accuracy, a smaller coverage area is needed. If, for example, significant changes to the environment are to be looked for during a new exploration of the deployment area, the chosen coverage area may be comparatively large. The detected changes can subsequently be examined with the degree of accuracy (and with a correspondingly adapted coverage area) needed to compile a map.

The coverage area may additionally depend on the objects or persons being sought after in the environment. The robot may receive a command to look for a certain person in the deployment area. Since a human body generally clearly stands out from a wall, the robot can maintain a greater distance to the walls while conducting the search. This allows a hallway or a large room to be quite efficiently searched. On the other hand, the sought after person may also be lying in a bed or on a sofa. In this case the robot will have to move much closer in order to recognize whether the sought after person is present.

FIG. 13 illustrates one such example. If the sought after object X is provided, for example, with an RFID chip by which the robot 100 can recognize and localize the object X, then the coverage area Z (and the accuracy of the localization) are theoretically given by the range of the RFID transceiver used. This coverage area Z can be modeled, for example, as a half sphere, in the center of which the robot (i.e. the RFID transceiver of the robot) is disposed. The radius of the half sphere corresponds to the range of the RFID transmission. On a plane, this coverage area manifests itself as a circle. In the vicinity of a piece of furniture (e.g. a bookshelf), it may make sense to reduce this coverage area Z (reduced coverage area Z′). If, for example, the coverage area is a circle with a radius of one meter and the sought after object Xis located on a sideboard (in FIG. 3, obstacle H) at a height of about one meter above the floor, then it will not suffice for the robot to move past the sideboard H at a distance of one meter because the object X will remain out of range. However, if the coverage area in the vicinity of obstacles such as furniture is adapted for the movement planning of the robot (e.g. reduced to a radius of approximately 20 cm, coverage area Z′), then there is a chance that the robot will detect the object on the sideboard. Thus, on the one hand, the coverage area may depend on the object that is sought after (an object with an RFID chip will be detected in a coverage area other than that in which, for example, the base station will be detected using, for example, an optical sensor) and, on the other hand, the coverage area may also depend on the orientation data contained in the map (in the vicinity of a contour of the obstacle the chosen coverage area will be smaller, for example).

The coverage area may also depend on the sensor data itself. For example, the degree of accuracy that can be achieved in measurements taken by an optical triangulation sensor depends greatly on the distance at which the measurements are made. At a distance of two meters, for example, the measurement tolerance may be, e.g. +/−10 cm, whereas at a distance of one half meter it is only +/−5 mm. Assuming, for example, that the coverage area Z of an optical triangulation sensor is three meters, if the robot detects and object that could be relevant to the search at a distance of 2 m, the coverage area can be reduced. This means that the robot will have to move closer to the object in order to completely search the area (because the track of the reduced coverage area Z′ will be marked as “searched”). If the robot once again distances itself from the object, the coverage area may again be enlarged.

The coverage area (or the reduced coverage area) will be marked in the map as “already searched” while the robot navigates through the deployment area. Thus the robot “knows” at every point in time which part of the deployment area has already been searched and the search can be planned in a structured manner. In addition to this, during the search the robot can make use of data already saved in the map. If the robot, for example, is instructed to find a new room, it will always be able to recognize it by its out walls recorded in the map. These can then be examined during the search with the highest priority.

If, for example, a person is to be looked for, this can be carried out in dependency on the time of day and on the places where the person usually can be found. In this manner the robot will begin such a search in the early morning hours, for example, in the bedroom and around noon the robot will start the search in the kitchen.

Thus, in accordance with the previously described criteria, the robot will determine one or more points and/or areas of the deployment area that are to be approached for the search. One of these points and/or areas may be given priority and chosen to be first, upon which the robot can plan a path to the chosen point and/or area (based on the map data) and will then be guided along this path towards it. During its approach, the robot, for example, can examine the chosen point or area with (long-range) sensor measurement and, if needed, change the prioritization. It may happen that a different point or area is assigned a higher priority and that the robot instead selects and approaches that point or area. The path of the robot can be correspondingly altered.

It is also possible, for example, that an area to be searched (search area) and/or a known area, in which the search is conducted, can be designated in the map. For example, the user may enter a search area via the HMI and thus, e.g., stipulate that the search be carried out in a certain room (e.g. living room). This room will then be marked as “to be searched”. Alternatively, the search area may be determined indirectly by designating the rest of the deployment area, with the exception of the area to be searched, as “known”. An area marked as “known” can be marked such, for example, as if it were already completely covered by the coverage area of the sensor.

The points and/or subareas that are to be approached for the search are determined based on the area to be searched (search area) or based on the area marked as known. For example, a point on or near the edge of the area to be searched or the known area can be approached.

If there are numerous points or areas to be chosen from, the points or areas may be selected, for example, that can be reached most quickly (based on the path planning in the existing map). As an alternative, for example, the shortest path to the point/area may be chosen. Alternatively, as described above, the distance of the points/areas to obstacles or other specific objects in the map may be used (e.g. near an outer wall or a bed). In addition to this, the properties of obstacles, objects, areas and/or rooms (e.g. the designation of a room) or the time of day are used.

The search may be continued until a criterion for ending it is fulfilled. One such criterion, for example, might be that the deployment area has been completely searched without finding the sought after object or person. This can be recognized by the fact that the coverage area saved in the map completely covers the deployment area saved in the map and/or the area to be searched. The search will also be ended, for example, once the sought after object or event is found. In this case the robot may move on to a different task or strategy. The search may also be continued until a specifiable number of objects or events are found.

Assessment of Changes to the Deployment Area—Since changes to the environment may have a disruptive affect on the navigation of the robot, it is helpful for the robot to be able to recognize such changes, assess them and to inform the user of an identified detected disruption. In such a case the robot, for example, may suggest to the user that the deployment area again be explored to recompile the map or that it be tidied up.

One value that can be very easily determined by the robot is the accessible area or the non-accessible area. The robot can determine this while navigating through its deployment area and while carrying out tasks. Based on this at least a value for the accessibility of a given area can be determined. This, for example, is the quotient of the accessible surface determined during the deployment (actual value) and of the (theoretically) accessible surface recorded in the permanently saved map (nominal value). This quotient may be expressed as a percentage. If this value falls below a predefined threshold, the user can be notified. Thus, if it is determined that the robot can only access, for example, 75% or less of the theoretically accessible surface, it can inform the user of this via the HMI.

A further example for a value that reflects the accessibility of a surface is the time needed to travel over the surface. For example, the quotient of the time per cleaned area can be determined and compared to a reference value. This can be determined, for example, for individual subareas (e.g. rooms). If the time needed for each surface is small, the robot can carry out its task (i.e. the cleaning) very efficiently. If, however, the robot was forced to maneuver around numerous obstacles while carrying out the cleaning, the time needed for each surface increases and efficiency of the performed task (i.e. the cleaning) is lowered. By comparing the time spent with a reference value, the robot can assess whether the efficiency with which the task was carried out lies within a usual tolerance or whether it is significantly compromised. If it is determined, for example, that the efficiency with which the task was carried out in a certain subarea is compromised, the robot may send a message to the user suggesting that this area be tidied up or again explored.

Further examples for the degree of accessibility of an area include the time spent within a subarea, the time per travelled path length or the entire path length needed for the performance of a task in the subarea.

In addition to this, the development over time and/or the place of the compromised efficiency may be taken into account. For this purpose, the surface determined to be accessible and/or a value for the accessibility can be saved for a given amount of time (i.e. a week, a month). The saved information can be taken into consideration when deciding whether and how the user is informed. For example, it may be determined with regard to a subarea marked as “children's room” that the accessible surface has diminished over a longer period of time (e.g. a week) or that it has remained very small. The robot may send a message to an HMI 200 that belongs to the children's room (e.g. the smartphone of the child) requesting that the room be tidied up. If this does not lead to an improvement, e.g. by the following day, a further message can be sent to a different HMI 200 (e.g. to the smartphone of the parents). Additionally or alternatively, a corresponding message can be sent to a social network.

It may also happen, for example, that an accessible surface is detected that is not recorded in the map. The robot may conclude from this that the unmapped surface is a new subarea (a new room) and suggest to the user that it be explored in order to correspondingly update the existing map. Here it should be noted that a new accessible surface can also be created by leaving the entrance door to a house or apartment open. It may therefore be advisable for the robot to wait for a confirmation from the user before exploring the new subarea.

When the accessible surface is determined it is also possible to verify whether a surface is accessible that is marked in the map as inaccessible. This may be an indication, for example, that furniture has been moved. Additionally or alternatively it is also possible to test whether a surface is accessible and lies outside of the mapped area. This will be an indication of a new and, as of yet, unmapped area (see above).

Additionally or alternatively it may be tested whether there are inaccessible surfaces that were accessible during a previous deployment and/or that were marked as accessible. This may be an indication of a new piece of furniture. In such a case the robot may suggest to the user an updated map. It may also be, however, that the piece of furniture was only temporarily placed where it was. In order to differentiate between these two possibilities, it can be determined what is preventing access to the surface. A large object designated with linear contours may indicate a piece of furniture. Smaller, scattered obstacles will generally indicate a temporary disturbance. An obstacle located at a wall will generally also be a piece of furniture or some other permanently placed object, whereas an irregularly shaped obstacle deposited in the middle of an open space (e.g. a travel bag) is generally a temporarily existing obstacle. Thus the inaccessible surface can be marked as due to a “temporary disruption” (a temporarily present obstacle) or to a “permanent disruption” (a permanently present obstacle). The classification can be performed, for example, as described, based on the detected geometric shape, size and position of the obstacle in the deployment area (e.g. relative to a wall or other obstacles). This classification of the disturbance may help to decide whether to suggest that the map be updated or that the user be reminded to tidy up the area in question.

1. A method comprising the following:
saving a map of a deployment area of an autonomous mobile robot, wherein the map contains orientation data that represents the structure of the environment in the deployment area and wherein the map contains metadata;
receiving a command via a communication unit of the robot that causes the robot to begin a renewed exploration of at least a part of the deployment area of the robot;
renewed exploration of at least one part of the deployment area, wherein the robot gathers information referring to the structure of its environment in the deployment area by means of a sensor;
updating the map of the deployment area, and
saving the updated map for use in the robot navigation during numerous future deployments of the robot,
wherein the updating of the map comprises the following:
determining changes in the deployment area based on the information referring to the structure of the environment gathered during the exploration and on the orientation data already saved in the map and
updating the orientation data and the metadata based on the determined changes.

2. The method of claim 1, further comprising:
carrying out a service task by the robot, wherein the orientation data contained in the saved map remains unchanged,
wherein the service task is, in particular, one of the following: a cleaning task, a transport task, an inspection task or an entertainment task.

3. The method of claim 1,
wherein the received command contains information that specifies the part of the deployment area that is to be newly explored, wherein the part to be newly explored may be the entire deployment area, a previously defined subarea or an area specified by the user.

4. The method of claim 1,
wherein the determination of changes in the deployment area includes the compilation of a new map and the determination of changes by comparing the new map with the saved map,
wherein metadata from the saved map is at least partially carried over into the new map;
wherein, after completion of the renewed exploration, the saved map is replaced by the new map.

5. The method of claim 1,
wherein the updating of the orientation data and of the metadata includes:
compiling a temporary work copy of the saved map and entering identified changes into the work copy.

6. The method of claim 1,
wherein the renewed exploration of at least one part of the deployment area includes:
navigating through the deployment area until the part to be explored has been completely covered by a coverage area of the sensor, and the map of the part to be explored encompasses an area enclosed at least by obstacles and by parts of the deployment area that are not to be explored.

7. The method of claim 1,
wherein structures in areas in which changes to the deployment area have been detected are scanned with the sensor with a higher degree of accuracy than in other areas.

8. The method of claim 7,
wherein the degree of accuracy of the detection is increased by one or more of the following:
increasing the time spent in an area, moving closer to obstacles, increasing the surface travelled over by the robot during exploration, reducing the speed of movement, increasing the scanning duration of the structures.

9. The method of claim 1, wherein the updating of the metadata includes one or more of the following:
adaptation of an area in which a service task is to be carried out by the robot;
adaptation of the size, shape and/or number of subareas in the deployment area;
adaptation of calendar data;
entering information regarding a floor covering on a newly identified surface based on adjacent surfaces; or
moving danger zones linked to obstacles or exclusion areas.

10. The method of claim 1, wherein updating the orientation data includes:
localizing the robot in the saved map; and
adapting the orientation data saved in the map based on the data gathered by the sensor regarding the structure in the environment of the deployment area.

11. canceled.

12. Method for an autonomous mobile robot that is configured to:
permanently save at least one map of a deployment area of the robot for use in further deployments of the robot, and
detect data regarding the environment of the robot in its deployment area by means of a sensor unit and, based on the data gathered by the sensor unit, detect and localize objects and/or events in a coverage area of the sensor;
the method comprising:
(A) navigating the robot through the deployment area based on the saved map in order to search it for sought after objects and/or events;
(B) determining the position of a sought after object and/or a sought after event with reference to the map after it has been detected and localized with the aid of the sensor unit
(C) entering, into the map, the surface of the deployment area covered by the coverage area of the respective sensor.
(D) repeating steps B and C until a termination criterion is fulfilled.

13. The method of claim 12, wherein the termination criterion includes one or more of the following conditions:
a specifiable number of sought after objects and/or events has been localized and entered into the map;
a specifiable part of the deployment area has been covered by the coverage area (Z) of the respective sensor.

14. The method of claim 12, wherein detecting sought after objects and/or events comprises the following:
recognizing discrepancies between the data regarding the environment of the robot gathered by the respective sensor and corresponding data recorded in the map;
recognizing a specifiable geometric pattern in the data regarding the environment of the robot gathered by the respective sensor;
recognizing a marking of an object;
recognizing an object in the data regarding the environment by means of image processing;
recognizing an object, a person or an animal based on a measured temperature.

15. The method of claim 12,
wherein the coverage area of the respective sensor is chosen in dependency on the data contained in the map and/or the type of object or event that is sought after and/or the data regarding the environment gathered by the sensor unit.

16. The method of claim 12, wherein the navigation of the robot further comprises:
determining points and/or areas in the deployment area that the robot is to approach for the search;
selecting one of the determined points and/or areas based on data contained in the existing map;
directing the robot towards the selected point and/or area.

17. The method of claim 16,
wherein the points and/or areas in a search area recorded in the map by means of user input are selected and, in particular, a point and/or area on the edge of the search area is selected.

18. The method of claim 16,
wherein the selection of a point and/or area is carried out based on one of the following criteria:
the length of the path to the respective point and/or area;
the distance of the respective point and/or area to an obstacle;
the distance of the respective point and/or area to specific objects recorded in the map;
properties of obstacles, objects, areas and/or subareas of the deployment area recorded in the map.

19. A method comprising:
compiling a map of a deployment area of an autonomous mobile robot during an exploration run through the deployment area, wherein the robot navigates through the deployment area and detects data regarding the environment and its own position with the aid of sensors;
detecting a problem that disrupts the navigation of the robot and, consequently, the compilation of the map;
determining a point in time and/or a place in the map compiled until detection of the problem that can be assigned to the detected problem;
detecting that an unimpeded navigation is again possible;
continuing the compilation of the map, taking into account the point in time and/or place assigned to the problem, wherein the robot determines its position in the map compiled until the detection of the problem and uses the information contained therein for the further compilation of the map.

20. The method of claim 19, wherein detecting a problem includes one or more of the following:
detecting an unsuccessful completion of a controlled movement;
detecting the loss of contact with the floor;
detecting significant slipping or drifting of the robot;
detecting an uncontrolled movement;
detecting inconsistencies in the compiled map;
detecting that the robot cannot leave a subarea, in particular that it cannot access an already mapped area.

21. The method of claim 19, wherein determining the point in time and/or the place to which the detected problem can be assigned includes one or more of the following:
determining the location at which the problem was detected;
determining the last position of the robot that is known with a specifiable degree of reliability;
analyzing the map data for consistency and determining at what point in time and/or in which area inconsistent map data was detected;
receiving a user input.

22. The method of claim 19, wherein detecting that an unimpeded navigation of the robot is again possible is based on one or more of the following criteria:
the robot begins a liberatory maneuver and can successfully complete it;
the robot is informed by a user input that it has been manually liberated by the user.

23. The method of claim 19, wherein taking into account the point in time and/or place assigned to the problem includes one or more of the following:
determining an exclusion area that the robot does not enter autonomously;
determining an area to be avoided that the robot only enters if this is needed to complete the compilation of the map;
linking the problem to a specific object and/or pattern detected by the robot and entering an area that is to be avoided or that is closed off when further similar objects and/or patterns are detected in the deployment area;
deleting map data that is at least partially based on sensor measurements made at or after the determined point in time and/or area.

24-37. canceled
